(19) United States
(12) Patent Application Publication
(10) Pub. No.: US 2020/0301410 A1
(43) Pub. Date: Sep. 24, 2020

(54) WIRELESS DEVICE, WIRELESS SYSTEM, COMMUNICATION METHOD, INFORMATION TRANSFER METHOD, INFORMATION TRANSFER DEVICE, INFORMATION TRANSFER SYSTEM, AND PROGRAM STORAGE MEDIUM

(71) Applicant: NEC CORPORATION, Tokyo (JP)

(72) Inventor: Norio YAMAGAKI, Tokyo (JP)

(73) Assignee: NEC CORPORATION, Tokyo (JP)

(21) Appl. No.: 16/765,688

(22) PCT Filed: Nov. 19, 2018
(86) PCT No.: PCT/JP2018/042660

§ 371 Date: May 20, 2020

(30) Foreign Application Priority Data
Nov. 21, 2017 (JP) 2017-223378

(51) Int. Cl. G05D 1/00; G08C 17/02; G08G 7/00

(52) U.S. Cl. CPC G05D 1/0022; G08G 7/00; G05D 1/0027; G08C 17/02

(57) ABSTRACT

In order to achieve reduction in traffic load in exchanging control information while ensuring the above-mentioned optimality in using a plurality of unmanned vehicles, the present invention provides a wireless device comprising: a derivation unit for deriving, from a first position, which is included in first control information sent and is the position of a generation-source wireless device that is a generation source of the first control information, and a second position, which is included in second control information sent by a candidate wireless device that is a candidate to which the first control information is transferred and is the position of the candidate wireless device, a distance between the generation-source wireless device and the candidate wireless device; a determination unit for calculating probability that the first control information is transferred to the candidate wireless device from a predetermined function.

### TECHNICAL FIELD

The present invention relates to a communication device that transfers received control information.

### BACKGROUND ART

In recent years, an unmanned vehicle called an unmanned X vehicle (UXV) has attracted attention. ‘X’ for the UXV takes various words. In the case of X=aerial, the UXV is an unmanned aerial vehicle (UAV). In the case of X=ground, the UXV is an unmanned ground vehicle (UGV).

There is an increasing demand to make use of such a UXV for various applications. For example, it is discussed that a plurality of unmanned vehicles forming a group achieve reduction in human risks and a safe and efficient operation in an area where it is difficult for a person to enter, such as check of a damage situation and a search for a disaster victim from above a disaster area.

Under an environment making use of such an unmanned vehicle, an unexpectable environmental change or event may occur. In order to accomplish a given operation by making use of a plurality of unmanned vehicles under such an environment, research and development are carried out relating to a control algorithm for individual unmanned vehicles to autonomously perform a collaborative operation.

For example, NPL 1 discloses a control algorithm that reconciles adaptability of individual unmanned vehicles and optimization in formation of individual unmanned vehicles in an unmanned vehicle group. This algorithm performs control in consideration of the following two indices in a comprehensive way. A first of the indices determines to which direction and to which position an individual unmanned vehicle is to move, based on information from a variety of sensors and the like provided in order for each unmanned vehicle to accomplish an operation. A second of the indices determines to which direction and to which position an individual unmanned vehicle is to move in consideration of a position of another unmanned vehicle, in order to execute a given operation collaboratively as a group.

PTL 1 discloses an approach for designating, by a node sending certain information, an area to which the information is to be transferred, and transferring the information to the area, in a wireless ad-hoc network.

PTL 2 discloses a wireless communication device that relays and transmits received data to another wireless communication device, stores device information identifying another wireless communication device with which a wireless communication is possible, and determines whether to relay received data to another wireless communication device.

PTL 3 discloses an ad-hoc communication device in which each device wirelessly communicates with another device in an autonomous and distributed way.

PTL 4 discloses a wireless device constituting a wireless communication network that is autonomously established and in which a wireless communication is performed between a transmission source and a transmission destination.

### CITATION LIST

### Patent Literature

PTL 1: Japanese Translation of PCT International Application Publication No. JP-T-2010-518863
PTL 2: International Publication No. WO 2016/152104
PTL 3: Japanese Unexamined Patent Application Publication No. 2008-092196
PTL 4: Japanese Unexamined Patent Application Publication No. 2007-235895

### Non Patent Literature

NPL 1: M. Ogawa, M. Emura, M. Ichien, and M. Yano, ““Autonomous and Adaptive Control”: Collaborative Swarm Control Algorithm Inspired by Adaptive Mechanism of Living Organisms,” in Proceedings of 2016 IEEE/OES Autonomous Underwater Vehicles (AUV), pp. 439 to 444, November 2016.

### SUMMARY OF INVENTION

### Technical Problem

As described in the paragraphs of Background Art, in order that individual unmanned vehicles autonomously perform a collaborative operation in an unmanned vehicle group, it is necessary to allow information to be exchanged between moving unmanned vehicles. In order to do that, for example, it is effective to connect the unmanned vehicles to each other by using a wireless network called an ad-hoc network and accomplish an operation while exchanging information.

For example, a search from above an area where it is impossible for a person to enter or the like is assumed. In that case, unmanned vehicles fly while configuring an ad-hoc network, from a local headquarter where a person takes command. The unmanned vehicles search for, for example, an object or a person to be searched for, while capturing a downward image.

At that time, it is assumed that an unmanned vehicle detects an object or a person to be searched for. In that case, a video and a picture captured by the unmanned vehicle having detected the object or the person can be transferred to the headquarter by multihopping over the ad-hoc network among the unmanned vehicles, and a person can perform checking in detail.

Herein, the control algorithm disclosed in NPL 1 is based on the premise that individual unmanned vehicles are connected by an ad-hoc network. Then, the control algorithm exchanges, by using the configured ad-hoc network, positional information relating to a position at which each unmanned vehicle is currently present and a variety of information necessary for accomplishing an operation.

Thus, there is an issue that, as the number of unmanned vehicles forming a group increases, information to be exchanged increases, resulting in an increase in traffic amount (an increase in a traffic load). In general, a wireless ad-hoc network has a narrow available network bandwidth. Thus, when a traffic load of information to be exchanged increases, a wireless ad-hoc network needs increased amount of time for exchanging information, which adversely affects efficient accomplishment of an operation. A bandwidth necessary for transferring information such as a video and a picture may be depleted.

Herein, it is assumed that optimization relating to formation of individual unmanned vehicles is considered in a group formed by a plurality of unmanned vehicles. In that case, it is considered that unmanned vehicles at a close distance have a large influence on each other relating to mutual movement and positions. It is also considered that unmanned vehicles at a far distance have a small influence on each other relating to mutual movement and positions.

Thus, when the control algorithm disclosed in PTL 1 is executed, control information of unmanned vehicles at a close distance needs to be acquired with high frequency. However, it is considered that, even when control information of unmanned vehicles at a far distance is acquired with low frequency, optimality relating to formation of individual unmanned vehicles is not remarkably deteriorated. Meanwhile, it is considered that acquiring no control information of unmanned vehicles at a far distance may be a factor in failing to maintain the above-described optimality. Therefore, it is considered that traffic amount relevant to exchange of control information over a wireless ad-hoc network to which an unmanned vehicle is connected can be possibly reduced by varying a rate of acquiring control information according to a distance between unmanned vehicles.

Herein, it is assumed that, as an approach for stopping transfer of control information according to a distance, for one thing, a method of providing a lifetime called a time-to-live (TTL) for control information is considered as a candidate. This method limits a range to which the control information is transferred, by, for example, setting the maximum hop count through which transfer is possible and an expiration time of transfer.

This approach stops transfer of the control information at a point in time when a set hop count or time is exceeded. However, when a hop count is set as a TTL, it cannot be unconditionally said that a distance between a generation-source unmanned vehicle in which the control information is generated and an unmanned vehicle receiving the control information is long, even when the hop count, that is, the number of unmanned vehicles through which the control information is transferred, is large. Similarly, when an expiration time is set as a TTL, it cannot be unconditionally said that a distance between a generation-source unmanned vehicle in which the control information is generated and an unmanned vehicle receiving the control information is long, even when the expiration time is expired.

Therefore, when such an approach is used, it may be impossible to vary a rate of received control information according to a distance.

Meanwhile, the approach disclosed in PTL 1 can set an area by a generation-source unmanned vehicle in which control information is generated. However, in the approach, control information is not transferred at all to an unmanned vehicle existing outside the area. Therefore, as described above, it is considered that the approach in PTL 1 cannot maintain the above-described optimality.

The present invention is made in order to solve the above-described issue.

An object of the present invention is to provide an information transfer method and the like that can reduce a traffic load relating to exchange of control information necessary for control of individual unmanned vehicles to autonomously perform a collaborative operation, while ensuring the above-described optimality in the case of using a plurality of unmanned vehicles. The optimality is optimality in adaptability of individual unmanned vehicles and formation of the individual unmanned vehicles in an unmanned vehicle group, in the case of accomplishing a given operation.

### Solution to Problem

A wireless device according to the present invention includes: a derivation unit that derives, from a first position that is included in sent first control information and is a position of a generation-source wireless device in which the first control information is generated, and a second position that is included in second control information to be sent by a candidate wireless device being a candidate for a device to which the first control information is transferred and is a position of the candidate wireless device, a distance between the generation-source wireless device and the candidate wireless device; a determination unit that calculates, by using a predetermined function that exhibits a tendency to decrease with an increase of the distance and always takes a positive value, a probability of transferring the first control information to the candidate wireless device; a transfer unit that performs the transfer based on the probability; and a sending unit that sends the first control information and the second control information to a movement control unit that controls autonomous movement by using the first control information and the second control information.

### Advantageous Effects of Invention

The information transfer method and the like according to the present invention is capable of reducing a traffic load relating to exchange of control information necessary for control by which individual unmanned vehicles autonomously perform a collaborative operation, while ensuring optimality in the case of using a plurality of unmanned vehicles.

### BRIEF DESCRIPTION OF DRAWINGS

FIG. 1 is a conceptual diagram illustrating a configuration example of a communication system according to a first example embodiment.

FIG. 2 is a conceptual diagram illustrating a configuration example of a communication device according to the first example embodiment.

FIG. 3 is a conceptual diagram illustrating a processing flow example of processing relating to transmission of control information prepared by an application unit.

FIG. 4 is a conceptual diagram illustrating a processing flow example of processing of transferring control information.

FIG. 5 is a conceptual diagram illustrating a processing flow example of processing performed by a transfer propriety determination unit.

FIG. 6 is an image illustrating how processing of transferring control information is performed by a general communication device.

FIG. 7 is an image illustrating how processing of transferring control information is performed by the communication device according to the first example embodiment.

FIG. 8 is a conceptual diagram illustrating processing of replacing processing of S305.

FIG. 9 is a conceptual diagram illustrating a processing flow example of processing performed by a transfer propriety determination unit according to a third example embodiment.

FIG. 10 is a block diagram illustrating a configuration example of a communication device according to a fourth example embodiment.

FIG. 11 is a conceptual diagram illustrating a hardware configuration example of an information processing device that can achieve the communication device according to the example embodiments.

FIG. 12 is a block diagram illustrating a minimum configuration according to the example embodiments.

### EXAMPLE EMBODIMENT

Next, example embodiments of the present invention will be described with reference to the drawings. The drawing schematically illustrates a configuration according to the example embodiment of the present invention. In addition, the example embodiment of the present invention described below is one example, and may be changed as appropriate within the scope of the identical essence.

### First Example Embodiment

A first example embodiment is an example embodiment relating to a communication system that varies, according to a distance between a generation-source communication device by which the control information is generated and a communication device being a candidate for a device to which the control information is transferred, the number of transmission destinations for transfer of control information. It is assumed herein that transfer is used synonymously with delivery.

### [Configuration and Operation]

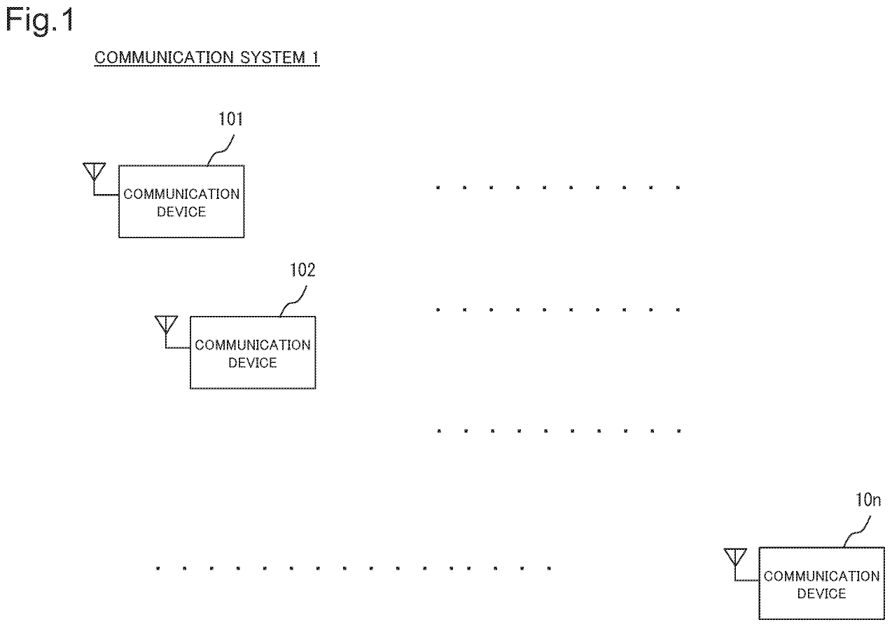

FIG. 1 is a conceptual diagram illustrating a configuration of a communication system 1 being an example of the communication system according to the first example embodiment.

The communication system 1 includes communication devices 101 to 10n being n communication devices. Herein, n is an integer equal to or more than 2.

The communication devices 101 to 10n mutually have a common configuration described below. Hereinafter, each of the communication devices 101 to 10n will be sometimes denoted simply as a “communication device”.

The communication device can perform wireless communication with another communication device, and is capable of a certain extent of autonomous movement. The communication device is, for example, an unmanned vehicle called an unmanned X vehicle (UXV) described in the paragraphs of Background Art.

The wireless communication is, for example, a communication performed through a connection to a wireless local area network (LAN) such as Wireless Fidelity (abbreviated as Wi-Fi, a registered trademark). The communication devices can perform the wireless communication in a mutual way, for example, by an ad-hoc mode.

The communication devices may be connected to each other over a wireless ad-hoc network using a wireless communication technology other than a wireless LAN. In that case, any two of the communication devices may perform wireless communication in a mutual way via the wireless communication network.

The communication devices are capable of movement as described above. For the movement, each of the communication devices includes, for example, an engine, a motor, a fuel tank and a storage battery powering the engine and the motor, a wheel, a propeller, and the like.

Besides the above, each of the communication devices includes, as needed, an information acquisition means for acquiring information on surroundings, such as a camera and a variety of sensors. In that case, each of the communication device may acquire, by using the information acquisition means, a variety of environment information and the like such as a picture of surroundings, a video of surroundings, a temperature, and a humidity.

Each of the communication devices generates control information including positional information and the like of the communication device. Each of the communication devices may exchange or share the control information with another communication device. The control information includes a device ID, positional information, and a sequence number thereof. Herein, an ID is an abbreviation of an identifier, and means an identifier. The device ID can identify a communication device generating the control information. The positional information is positional information of the communication device acquired from global positioning system (GPS) information and the like. The sequence number is an information ID being able to identify generated control information for at least a certain period of time.

Each of the communication devices may transfer, to another communication device, a content such as a picture, a video, and sensing information acquired by using a camera and a variety of sensors included as needed.

Each of the communication devices transfers the control information and the content directly to a neighboring communication device, or alternatively, transfers the control information and the content by multihopping via a plurality of communication devices. Herein, a neighboring communication device of a certain communication device refers to a communication device existing within a range where a direct communication is possible mutually with the communication device by performing the wireless communication without being interposed by another communication device.

Each of the communication devices may recognize each other between the communication device and the neighboring communication device, by, for example, periodically broadcasting, to a periphery thereof, an administrative message that is called a beacon being a well-known art.

Alternatively, each of the communication devices and the neighboring communication device of the communication device may recognize each other, by using the control information. Such a method of detecting a neighboring communication device in an ad-hoc network is a well-known art, and thus, will not be described in detail.

In the following description, a communication device generating control information or content data will be referred to as a generation-source communication device in which control information or content data is/are generated. A communication device transmitting control information or content data to another communication device will be referred to as a transmission-source communication device from which control information or content data is/are transmitted, regardless of whether the control information or the content data is/are generated by the communication device. The generation-source communication device and the transmission-source communication device may be an identical communication device, or may be different communication devices.

The communication device according to the present example embodiment may share the control information generated by the communication device between the communication devices included in the communication system 1, by transferring the control information therebetween. For the transfer, for example, transfer methods based on flooding and an epidemic method being well-known arts may be used.

In a transfer method based on flooding, it is assumed that a certain communication device receives the control information transmitted by a neighboring communication device of the communication device. In that case, the communication device having received the control information transfers the control information to another of the neighboring communication devices other than the transmission-source communication device from which the control information is transmitted. As a transfer method relating to the transfer, use of broadcasting or multicasting can be also contemplated, as will be described in a third example embodiment. However, according to the present example embodiment, transfer through unicasting is assumed.

Consequently, a certain communication device may possibly receive the identical control information from a plurality of other communication devices. In the information transfer method according to the present example embodiment, it is assumed that, when pieces of received control information are duplicated, the communication device receiving the control information discards the duplicated pieces of control information. As described above, control information includes an information ID identifying the control information. Thus, the duplicated pieces of control information can be discarded by deleting pieces of control information having the same information ID while leaving one of the pieces.

Alternatively, duplication of the control information may be prevented by using multipoint relay (MPR) in optimized link state routing (OLSR) being a well-known routing protocol, and the like.

In a transfer method based on an epidemic method, each of the communication devices periodically transmits and receives, to and from a neighboring communication device, a message including a summary vector stored in the communication device, and exchanges the summary vector. Herein, a summary vector is a list of contents including the control information held by the communication device. Each of the communication devices detects, based on a summary vector received from another communication device, a difference between contents held by the communication device and contents stored in the another communication device being a transmission source of the summary vector. Then, in order to eliminate the difference, each of the communication devices transmits, to the communication device being the transmission source of the summary vector, a content request requesting for transmission of a content as the difference.

Then, the communication device having received the content request transmits the requested content to the communication device having transmitted the content request. Such transfer of a content based on a content request is called pull-type transfer.

Alternatively, in the present transfer method, each of the communication devices may perform push-type transfer in which a communication device having detected, based on a summary vector, a content not stored in a communication device having transmitted the summary vector transmits the content to the communication device having transmitted the summary vector.

The communication device according to the present example embodiment utilizes a well-known art as described above, and determines a neighboring communication device to which the control information is transferred through unicasting. Therefore, in the following description, description will be given by assuming that a neighboring communication device being a transmission destination to which the control information is transferred by a certain communication device is already recognized by the communication device according to a well-known art as described above.

In the case of transmitting content data acquired by a camera and a variety of sensors included in a communication device to a particular communication device, transfer can be performed based on a routing protocol being a well-known art.

On the basis of the premise as described above, the communication device according to the present example embodiment will be described below.

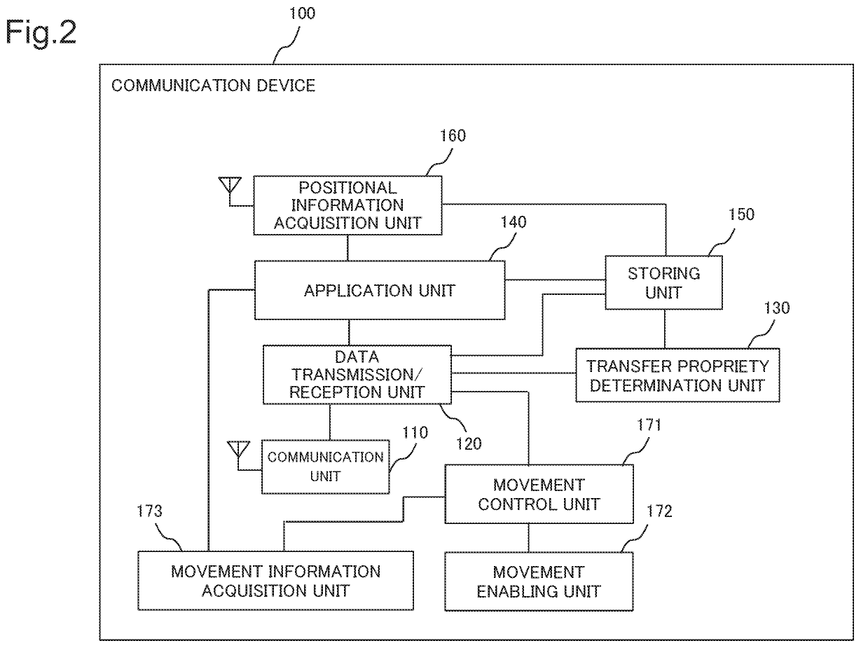

FIG. 2 is a conceptual diagram illustrating a configuration of a communication device 100 being an example of the communication device according to the present example embodiment.

The communication device 100 includes a communication unit 110, a data transmission/reception unit 120, a transfer propriety determination unit 130, an application unit 140, a storing unit 150, and a positional information acquisition unit 160. The communication device 100 further includes a movement control unit 171, a movement enabling unit 172, and a movement information acquisition unit 173.

The communication device 100 includes, besides the configuration illustrated in FIG. 2, the above-described configuration and the like relating to movement, photographing of a picture and a video, and sensing. These configurations are operated by control of the application unit 140. The control can be achieved by using a well-known art, and thus, will not be described in detail.

The communication unit 110 includes a communication module such as, for example, a wireless LAN, for connecting to an unillustrated network processing unit described below and a wireless communication network configured between the communication devices in the communication system 1 illustrated in FIG. 1. The network processing unit performs, for example, processing of a transport layer such as a TCP or a UDP, processing on a network layer such as an IP, and processing of MAC and the like controlled by a kernel of an OS. Herein, an OS is an abbreviation of an operating system. A TCP is an abbreviation of a transmission control protocol, and a UDP is an abbreviation of a user datagram protocol. An IP is an abbreviation of an internet protocol, and MAC is an abbreviation of media access control.

The data transmission/reception unit 120, the transfer propriety determination unit 130, and the application unit 140 are, for example, a central processing unit (CPU) executing processing in accordance with program control. The data transmission/reception unit 120, the transfer propriety determination unit 130, and the application unit 140 execute processing in accordance with, for example, control of application software running on the basis of an OS mounted on the communication device 100.

The data transmission/reception unit 120 transmits and receives control information and content data such as a picture and a video transmitted and received to and from the application unit 140, to and from the above-described neighboring communication device via the communication unit 110.

Further, the data transmission/reception unit 120 determines whether a communication device with which the communication device 100 communicates is the neighboring communication device of the communication device 100. Then, the data transmission/reception unit 120 causes the storing unit 150 to store a list of neighboring communication devices of the communication device 100.

Further, when receiving the control information from a neighboring communication device, the data transmission/reception unit 120 causes the transfer propriety determination unit 130 to determine whether to transfer the received control information to another neighboring communication device other than the transmission-source communication device from which the control information is transmitted. Then, when the determination result indicates transfer of the control information, the data transmission/reception unit 120 transfers the control information to the another neighboring communication device.

Further, the data transmission/reception unit 120 sends, to the movement control unit 171, control information received from another communication device.

The communication unit 110 radiates a radio wave including information indicated by the data transmission/reception unit 120, to a wireless space through an antenna included in the communication unit 110.

Further, the communication unit 110 converts a radio wave arriving at an antenna included in the communication unit 110 into reception information, and sends the reception information to the data transmission/reception unit 120.

The transfer propriety determination unit 130 determines whether to transfer control information received by the data transmission/reception unit 120 to another neighboring communication device 100 different from a transmission-source communication device from which the control information is transmitted.

When performing the determination, the transfer propriety determination unit 130 extracts a device ID, positional information of the generation-source communication device being a communication device that is a generation source of the control information, and an information ID from the control information received by the data transmission/reception unit 120. The extracted device ID is a device ID of the generation-source communication device. The extracted information ID is an information ID of the control information.

The transfer propriety determination unit 130 determines, based on the extracted positional information of the generation-source communication device and positional information of a neighboring communication device being a transmission destination candidate, whether to transfer the control information. Then, the transfer propriety determination unit 130 sends a determination result relating to the determination to the data transmission/reception unit 120.

The application unit 140 generates content data as needed. The application unit 140 causes the data transmission/reception unit 120 to transmit the content data to another communication device.

The application unit 140 acquires positional information from the positional information acquisition unit 160, for example, at a preliminarily set timing for generating control information. The application unit 140 causes the storing unit 150 to hold recent positional information of the communication device 100 acquired from the positional information acquisition unit 160.

The application unit 140 generates control information including recent positional information of the communication device 100, a device ID of the communication device 100, and a sequence number being an information ID of the control information, and sends the control information to the data transmission/reception unit 120.

Further, when receiving control information generated by another communication device, the application unit 140 causes the storing unit 150 to store positional information of the another communication device included in the control information. The application unit 140 causes the storing unit 150 to store the positional information together with a device ID of the another communication device and an information ID of the control information.

At that time, when the storing unit 150 already holds positional information of the another communication device, the application unit 140 determines whether an information ID of the control information is newer than an information ID of control information already stored in the storing unit 150. Then, when it is determined that the information ID of the control information is newer than the information ID of the control information already stored in the storing unit 150, the application unit 140 causes the storing unit 150 to update the positional information.

Further, as needed, the application unit 140 photographs a picture and a video by using an unillustrated camera and the like, and converts the picture and the video into content data. Further, as needed, the application unit 140 converts sensor information acquired from a variety of unillustrated sensors into content data. The application unit 140 causes the data transmission/reception unit 120 to transfer the generated content data to another communication device.

The storing unit 150 is, for example, a storage medium such as a memory. The storing unit 150 preliminarily holds a variety of information necessary for achieving the information transfer method according to the present example embodiment. The information includes a program and information necessary for each of the application unit 140, the data transmission/reception unit 120, and the transfer propriety determination unit 130 to perform the above-described operation.

Further, the storing unit 150 stores information indicated by each of the application unit 140, the data transmission/reception unit 120, and the transfer propriety determination unit 130. The information may include, for example, the above-described content data prepared by the application unit 140, a list of device IDs of other communication devices, the above-described determination results, and the like.

Further, the storing unit 150 sends information indicated by each of the application unit 140, the data transmission/reception unit 120, and the transfer propriety determination unit 130 to any of the application unit 140, the data transmission/reception unit 120, or the transfer propriety determination unit 130 being an indicated transmission destination.

The positional information acquisition unit 160 successively acquires positional information of the communication device 100 by using a GPS and the like. The positional information acquisition unit 160 sends, in response to a request from the application unit 140, positional information of the communication device 100 at a current time point to the application unit 140.

The movement information acquisition unit 173 acquires movement information being information necessary for the movement control unit 171 to prepare control information to be sent to the movement enabling unit 172. The movement information includes positional information of the communication device 100 or another communication device, and also includes speed information, acceleration information, image information, and the like. The movement information acquisition unit 173 acquires the positional information from the application unit 140. The movement information acquisition unit 173 acquires movement information other than the positional information from a variety of sensors included in the movement information acquisition unit 173. The movement information acquisition unit 173 sends the acquired information to the movement control unit 171.

The movement control unit 171 generates a control signal, based on the information sent from the movement information acquisition unit 173 and the control information, and sends the generated control signal to the movement enabling unit 172. The control signal indicates, for example, a direction of movement and a movement speed to the movement enabling unit 172. The control signal causes the movement enabling unit 172 to perform a certain extent of autonomous movement of the communication device 100.

The movement enabling unit 172 performs movement of the communication device 100 in accordance with the control signal sent from the movement control unit 171. The movement enabling unit 172 causes the communication device 100 to move by means of rotation and the like of a propeller, a wheel, and the like according to the control signal from the movement control unit 171.

### [Processing Flow Example]

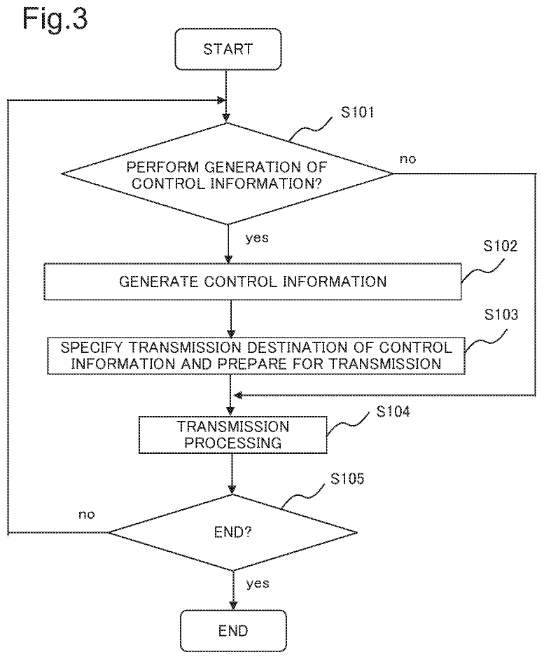

FIG. 3 is a conceptual diagram illustrating a processing flow example of processing performed by the application unit 140 illustrated in FIG. 2 and relating to transmission of control information prepared by the application unit 140.

The application unit 140 starts the processing illustrated in FIG. 3, for example, upon external input of start information. The start information is, for example, information for activating a program causing the application unit 140 to operate.

Then, as processing of S101, the application unit 140 performs determination as to whether to generate and transmit control information. The application unit 140 performs the determination by, for example, determining whether a timing for generating control information has come. Herein, the timing for generating control information is preliminarily set to, for example, one-second intervals and the like. Herein, the application unit 140 is assumed to be able to use a timer.

When a determination result in the processing of S101 is yes, the application unit 140 performs processing of S102.

Meanwhile, when a determination result in the processing of S101 is no, the application unit 140 performs processing of S104.

When performing the processing of S102, the application unit 140 generates control information as the processing. At that time, the application unit 140 acquires latest positional information from the positional information acquisition unit 160. Then, the application unit 140 generates control information including the acquired latest positional information, a device ID of the communication device 100, and an information ID of the control information. A device ID of the communication device 100 is, for example, a MAC address and an IP address of the communication device 100.

Then, as processing of S103, the application unit 140 specifies a transmission destination of the control information, and performs transmission preparation of the control information.

For example, when control information is delivered based on the above-described pull-type, the application unit 140 sets a transmission source of the content request as a transmission destination of the control information. Specifically, the application unit 140 sets, as an identifier of the control information, for example, a combination of the device ID and the information ID included in the control information generated in S102, generates a summary vector including the identifier, and exchanges the summary vector as a message with a neighboring communication device. Since the neighboring communication device does not hold the control information, the neighboring communication device sends a content request to the communication device. A transmission-destination communication device to which the control information is sent is the transmission-source communication device from which the content request is sent. As the processing, a communication device causes the storing unit 150 to record a device ID of the specified transmission-destination communication device. The device ID of the transmission-destination communication device is, for example, a MAC address or an IP address of the transmission-destination communication device. As a specified transmission destination, one or more communication devices may be set as transmission destinations. When a method of delivering control information is based on the above-described flooding, all neighboring communication devices may be set as transmission destinations.

The transmission preparation means, for example, storing of generated control information in a transmission buffer included in the storing unit 150.

Then, as the processing of S104, the application unit 140 causes the data transmission/reception unit 120 to transmit the control information prepared for transmission in the processing of S103 to the specified transmission-destination communication device.

At a time of performing the processing of S104, when there is another piece of data to be sent, the application unit 140 may cause the data transmission/reception unit 120 to send the another piece of data. The another piece of data is, for example, the above-described content data. When the application unit 140 causes the data transmission/reception unit 120 to send the another piece of data, the application unit 140 stores, for example, the another piece of data in the transmission buffer.

Then, as processing of S105, the application unit 140 performs determination as to whether to end the processing illustrated in FIG. 3. The application unit 140 performs the processing by, for example, determining presence or absence of external input of end information. The end information is, for example, information for ending an operation of a program causing the application unit 140 to operate.

When a determination result in the processing of S105 is yes, the application unit 140 ends the processing illustrated in FIG. 3.

Meanwhile, when a determination result in the processing of S105 is no, the application unit 140 performs the processing of S101 again.

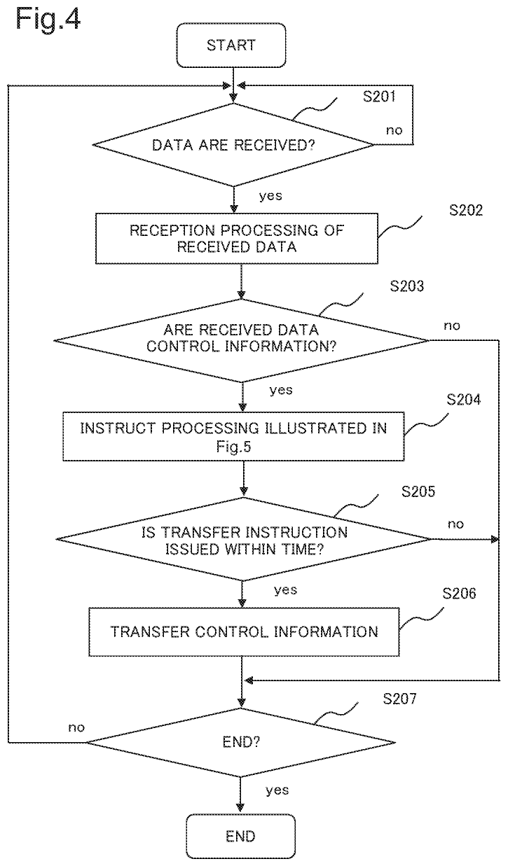

FIG. 4 is a conceptual diagram illustrating a processing flow example of processing of transferring control information performed by the data transmission/reception unit 120 illustrated in FIG. 2.

The data transmission/reception unit 120 starts the processing illustrated in FIG. 4, for example, upon external input of start information. The start information is, for example, information for activating a program for causing the data transmission/reception unit 120 to operate.

Then, as processing of S201, the data transmission/reception unit 120 performs determination as to whether data is sent from the communication unit 110. The data may include the above-described control information and the above-described content data.

When a determination result in the processing of S201 is yes, the data transmission/reception unit 120 performs processing of S202.

When a determination result in the processing of S201 is no, the data transmission/reception unit 120 performs the processing of S201 again.

When performing the processing of S202, the data transmission/reception unit 120 performs, as the processing, reception processing of data sent from the communication unit 110. The reception processing is, for example, as follows.

The data transmission/reception unit 120 performs reception processing according to whether a type of received data received via the communication unit 110 is control information or content data.

When the received data is control information, the data transmission/reception unit 120 sends the received control information to the application unit 140, and causes the application unit 140 to perform the following processing.

Upon receiving an instruction from the data transmission/reception unit 120, the application unit 140 extracts positional information of a generation-source communication device in which the control information is generated, a device ID of the generation-source communication device, and a sequence number being an information ID of the control information that are included in the control information. Hereinafter, positional information of a generation-source communication device in which control information is generated, a device ID of the generation-source communication device, and a sequence number being an information ID of the control information that are included in the control information will be also referred to as message information. The application unit 140 causes the storing unit 150 to hold the message information.

When the application unit 140 attempts to cause the storing unit 150 to hold message information, the storing unit 150 may sometimes already hold positional information of the generation-source communication device. In that case, for example, when the application unit 140 determines that an information ID of the control information is newer than a sequence number of control information held by the storing unit 150, the application unit 140 updates the positional information.

Meanwhile, when the received data is content data, the data transmission/reception unit 120 sends the received data to the application unit 140. In that case, the application unit 140 performs, on the received data, processing preliminarily defined as an application.

When the data transmission/reception unit 120 receives control information generated by a neighboring communication device, the data transmission/reception unit 120 causes the storing unit 150 to hold a device ID of the neighboring communication device through the above-described processing.

Next, as processing of S203, the data transmission/reception unit 120 performs determination as to whether the data on which reception processing is performed in the processing of S202 is control information.

When a determination result in the processing of S203 is yes, the data transmission/reception unit 120 performs processing of S204.

Meanwhile, when a determination result in the processing of S203 is no, the data transmission/reception unit 120 performs processing of S207.

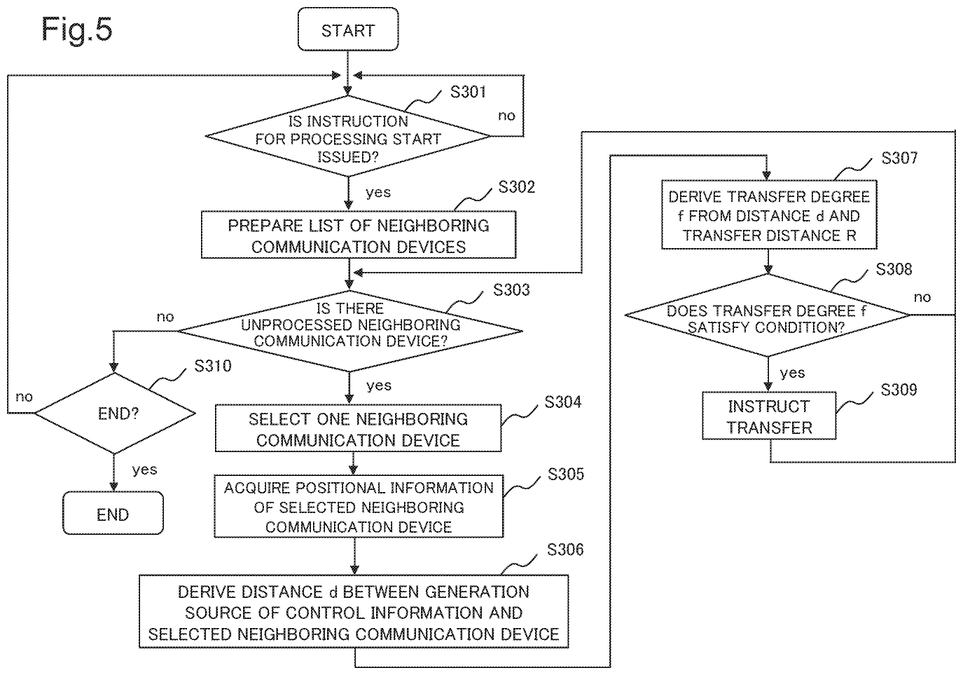

When performing the processing of S204, the data transmission/reception unit 120 causes, as the processing, the transfer propriety determination unit 130 illustrated in FIG. 2 to perform processing illustrated in FIG. 5 described later. At that time, the data transmission/reception unit 120 sends the message information to the transfer propriety determination unit 130.

Then, as processing of S205, the data transmission/reception unit 120 performs determination as to whether a transfer instruction for the message information is issued by the transfer propriety determination unit 130 before a time period Tth elapses after the processing of S204 is performed. Herein, the time period Tth is a time period preliminarily set in such a way that, when the transfer propriety determination unit 130 sends the transfer instruction in response to the message information, the transfer propriety determination unit 130 sends the transfer instruction by a time when the time period Tth elapses.

When a determination result in the processing of S205 is yes, the data transmission/reception unit 120 performs processing of S206.

Meanwhile, when a determination result in the processing of S205 is no, the data transmission/reception unit 120 performs the processing of S207.

When performing the processing of S206, the data transmission/reception unit 120 causes, as the processing, the communication unit 110 illustrated in FIG. 2 to perform transfer of latest control information. A neighboring communication device being a transmission destination of the transfer is designated by the transfer propriety determination unit 130 at a time of processing of S309 in FIG. 5, as will be described later.

Then, as the processing of S207, the data transmission/reception unit 120 performs determination as to whether to end the processing illustrated in FIG. 4. The data transmission/reception unit 120 performs the determination by, for example, determining presence or absence of external input of end information. The end information is, for example, information for ending an operation of a program causing the data transmission/reception unit 120 to operate.

When a determination result in the processing of S207 is yes, the data transmission/reception unit 120 ends the processing illustrated in FIG. 4.

Meanwhile, when a determination result in the processing of S207 is no, the data transmission/reception unit 120 performs the processing of S201 again.

FIG. 5 is a conceptual diagram illustrating a processing flow example of processing performed by the transfer propriety determination unit 130 illustrated in FIG. 2.

The transfer propriety determination unit 130 starts the processing illustrated in FIG. 5, for example, upon external input of start information. The start information is, for example, information for activating a program for causing the transfer propriety determination unit 130 to operate.

Then, as processing of S301, the transfer propriety determination unit 130 performs determination as to whether an instruction for starting the processing illustrated in FIG. 5 is issued by the data transmission/reception unit 120. The instruction is an instruction illustrated as S204 in FIG. 4. As described above, the instruction is issued together with sending of the message information.

When a determination result in the processing of S301 is yes, the transfer propriety determination unit 130 performs processing of S302.

Meanwhile, when a determination result in the processing of S301 is no, the transfer propriety determination unit 130 performs the processing of S301 again.

When performing the processing of S302, the transfer propriety determination unit 130 prepares, as the processing, a list of neighboring communication devices, and causes the storing unit 150 illustrated in FIG. 2 to store the list. When there is no neighboring communication device, the transfer propriety determination unit 130 prepares an empty list, and causes the storing unit 150 to store the list.

Then, as processing of S303, the transfer propriety determination unit 130 performs determination as to whether there is a neighboring communication device not yet subjected to processing of S304 in the list prepared in latest processing of S302.

When a determination result in the processing of S303 is yes, the transfer propriety determination unit 130 performs the processing of S304.

Meanwhile, when a determination result in the processing of S303 is no, the transfer propriety determination unit 130 performs processing of S310.

When performing the processing of S304, the transfer propriety determination unit 130 selects, as the processing, one neighboring communication device included in the list prepared in the latest processing of S302 and not yet subjected to the processing of S304.

Then, as the processing of S305, the transfer propriety determination unit 130 acquires, from the storing unit 150 illustrated in FIG. 3, latest positional information of the neighboring communication device selected in the processing of S304. As described above, the storing unit 150 holds latest positional information of a generation-source communication device in which received control information is generated, in association with a device ID of the generation-source communication device. The generation-source communication device includes a neighboring communication device. Thus, the transfer propriety determination unit 130 can acquire latest positional information of the selected neighboring communication device from the storing unit 150.

Next, as processing of S306, the transfer propriety determination unit 130 derives a distance d between a transmission-source communication device from which the control information is transmitted and the neighboring communication device selected in the processing of S304.

It is assumed that positional information is represented by three-dimensional (x, y, and z directions) coordinates, positional information of the generation-source communication device is (xi, yi, zi), and positional information of the neighboring communication device is (xj, yj, zj). In that case, the distance d can be derived by using the following expression (1).

d={square root over ((xᵢ−xⱼ)²+(yᵢ−yⱼ)²+(zᵢ−zⱼ₎²)} (1)

Then, as processing of S307, the transfer propriety determination unit 130 derives a transfer degree f from the distance d derived in the processing of S306 and a predetermined constant R (called a transfer distance). The transfer degree f is given as a function g(d) of the distance d between a generation-source communication device in which the control information is generated and a neighboring communication device to be processed. The function g(d) gives a larger value as the distance d becomes larger.

The transfer propriety determination unit 130 derives the transfer degree f by using, for example, the following expression (2).

f=g(d)=2^{ceiling(d/R)-1} (2)

Herein, ceiling(x) means the minimum integer equal to or more than x. A reciprocal of the transfer degree f is a value representing a degree of probability that control information is transferred according to a distance between a generation-source communication device in which the control information is generated and a neighboring communication device to be processed being a destination to which the control information is transferred. The transfer degree f=1 means that control information generated by a generation-source communication device in which the control information is generated is transferred every time. The transfer degree f=16 means that control information generated by a generation-source communication device in which the control information is generated is transferred once every sixteen times.

Next, as processing of S308, the transfer propriety determination unit 130 performs determination as to whether the transfer degree f derived in the processing of S307 satisfies a preliminarily set condition.

The condition is that, for example, division of a sequence number s being an information ID of the control information by the transfer degree f leaves a remainder of zero. Accordingly, it is determined that the condition is satisfied once every f times. In other words, a probability that transfer is executed is 1/f.

When a determination result in the processing of S308 is yes, the transfer propriety determination unit 130 performs processing of S309.

Meanwhile, when a determination result in the processing of S308 is no, the transfer propriety determination unit 130 performs the processing of S303 again.

When performing the processing of S309, the transfer propriety determination unit 130 instructs, as the processing, the data transmission/reception unit 120 to transfer control information sent by the data transmission/reception unit 120 to the transfer propriety determination unit 130. The instruction is performed together with sending of a device ID of the neighboring communication device selected in the latest processing of S304 to the data transmission/reception unit 120.

Then, the transfer propriety determination unit 130 performs the processing of S303 again.

When performing the processing of S310, the transfer propriety determination unit 130 performs, as the processing, determination as to whether to end the processing illustrated in FIG. 5. The transfer propriety determination unit 130 performs the determination by, for example, determining presence or absence of external input of end information. The end information is, for example, information for ending an operation of a program causing the transfer propriety determination unit 130 to operate.

### [Specific Example]

Next, a specific example of processing of transferring control information performed by the communication device according to the present example embodiment will be described.

Next, an advantageous effect acquired by a transfer system according to the present example embodiment will be described in comparison with a case of a general transfer system.

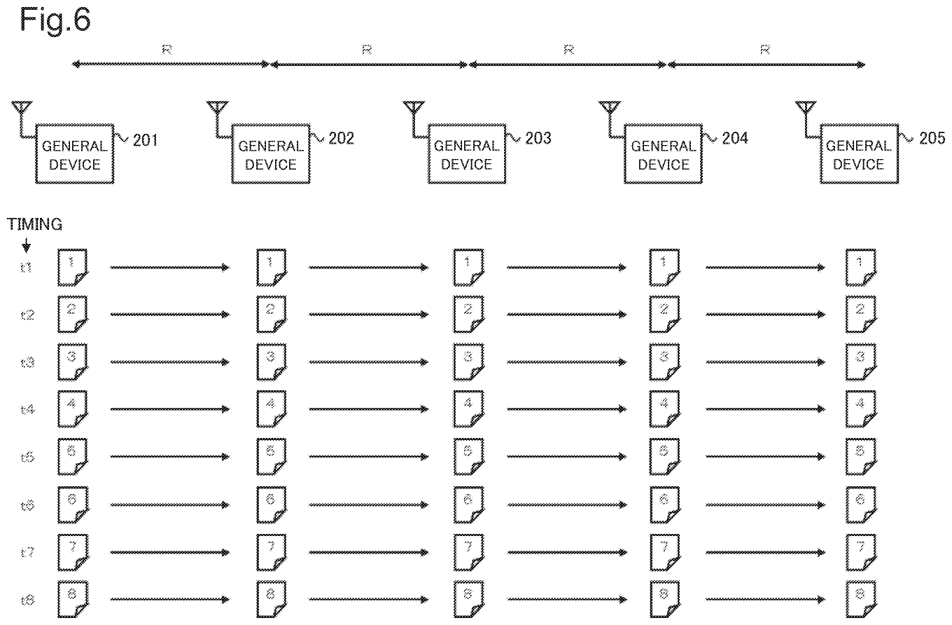

FIG. 6 is an image illustrating how processing of transferring control information is performed by general devices 201 to 205 being examples of a general communication device.

In FIG. 6, the general devices 201 to 205 are arranged in a row in such a way that an interval between two adjacent general devices become a constant distance R. Transfer of control information may be performed directly between two adjacent general devices illustrated in FIG. 6.

Each rectangular shape with sort of a turned-up lower right corner illustrated in FIG. 6 represents control information. A numerical character written in each piece of control information is an information ID of the control information.

Herein, it is assumed that the general device 201 sends each piece of control information having information IDs 1 to 8 to the general device 202 at timings t1 to t8 sequentially in this order, as illustrated in FIG. 6.

Then, the general device 202 transfers the each piece of control information received from the general device 201 to the general device 203.

Then, the general device 203 transfers the each piece of control information received from the general device 202 to the general device 204.

Then, the general device 204 transfers the each piece of control information received from the general device 203 to the general device 205.

As described above, the general system illustrated in FIG. 6 has a large traffic load relating to exchange of control information necessary for control to perform an autonomous collaborative operation.

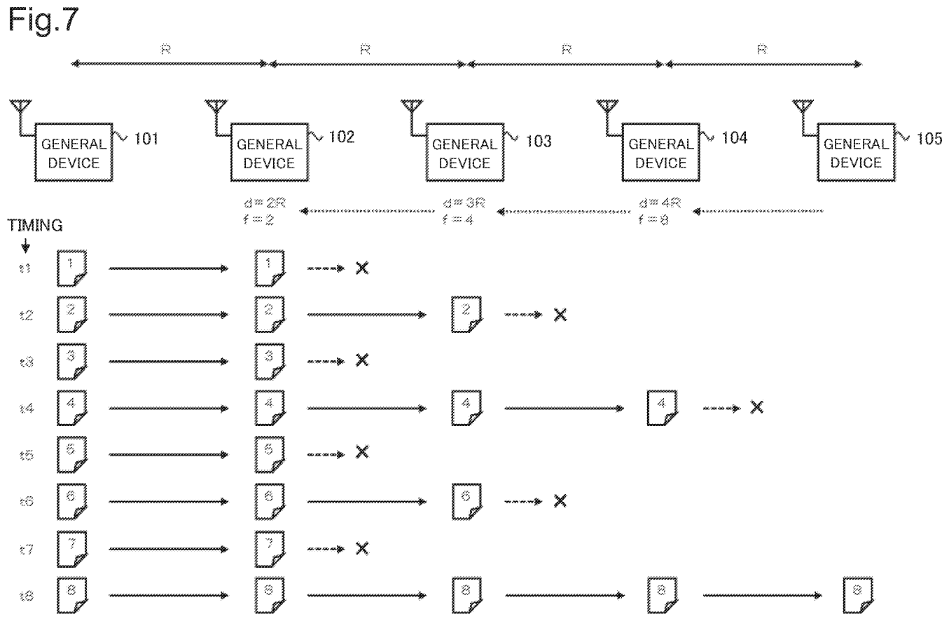

FIG. 7 is an image illustrating how processing of transferring control information is performed by the communication devices 101 to 105 being examples of the communication device according to the present example embodiment.

In FIG. 7, the communication devices 101 to 105 are arranged in a row in such a way that an interval between two adjacent communication devices becomes a constant R. Transfer of control information may be performed directly between two adjacent communication devices illustrated in FIG. 7.

Each rectangular shape with sort of a turned-up lower right corner illustrated in FIG. 7 represents control information. A numerical character written in each piece of control information is an information ID of the control information.

Herein, it is assumed that the communication device 101 sends each piece of control information having information IDs 1 to 8 to the communication device 102 at timings t1 to t8 sequentially in this order, as illustrated in FIG. 7.

Then, through the processing of S306 illustrated in FIG. 5, the communication device 102 derives a double of the constant R as a distance d. Then, through the processing of S307 in FIG. 5, the communication device 102 derives f=2 as a transfer degree f by using the above-described expression (2).

Then, the communication device 102 transfers, to the communication device 103, only pieces of control information having information IDs 2, 4, 6, and 8 among the each piece of control information received from the communication device 101. Herein, the condition in the processing of S308 is based on a premise that an information ID of control information divided by the transfer degree f leaves a remainder of zero.

Next, similarly, the communication device 103 derives d=3R and f=4, and transfers, to the communication device 104, only pieces of control information having an information ID 4 or 8 among the each piece of control information received from the communication device 102.

Next, similarly, the communication device 104 derives d=4R and f=8, and transfers, to the communication device 105, only a piece of control information having an information ID 8 among the each piece of control information received from the communication device 103.

In this way, in the communication system according to the present example embodiment illustrated in FIG. 7, as a distance d from a generation-source communication device in which control information is generated to a neighboring communication device increases, a probability that the control information reaches the neighboring communication device decreases. Thus, the communication system according to the present example embodiment reduces a traffic load relating to exchange of control information necessary for control of individual communication devices to autonomously perform a collaborative operation.

However, in the communication system according to the present example embodiment illustrated in FIG. 7, even when a distance d from a generation-source communication device in which control information is generated to a neighboring communication device being a transmission destination increases, a probability that the control information reaches the neighboring communication device being the transmission destination does not become zero. As described in the paragraphs of Technical Problem, in order to ensure the above-described optimality in the case of using communication devices, it is important that a probability that control information generated by any communication device reaches the communication devices does not become zero. Therefore, the communication system according to the present example embodiment can enable ensuring the above-described optimality in the case of using communication devices.

### [Advantageous Effect]

As described in the paragraphs of Technical Problem, in order to ensure the above-described optimality in the case of using communication devices, it is important that a probability that control information generated by any communication device reaches the communication devices does not become zero. In order to reduce a traffic load relating to exchange of control information necessary for control of individual communication devices to autonomously perform a collaborative operation, it is effective that, as a distance d increases, a probability that control information reaches individual unmanned vehicles decreases.

The communication device according to the present example embodiment derives, when control information is sent from another communication device, a probability of transferring the control information, based on a distance d between a generation-source communication device in which the control information is generated and each neighboring communication device. The probability becomes smaller when the distance d increases, although does not becomes zero.

Therefore, the communication device according to the present example embodiment can reduce a traffic load relating to exchange of control information necessary for control of individual unmanned vehicles to autonomously perform a collaborative operation, while ensuring the above-described optimality in the case of using a plurality of unmanned vehicles.

### Second Example Embodiment

A second example embodiment is an example embodiment relating to a communication system that sets a unique constant R for each communication device.

### [Configuration and Operation]

An example of a communication system according to the second example embodiment is the same as the communication system 1 illustrated in FIG. 1. Description of a communication system 1 according to the second example embodiment is the same as the description of the communication system 1 according to the first example embodiment illustrated in FIG. 1, except for the following description about communication devices.

An example of a communication device according to the second example embodiment is the same as the communication device 100 illustrated in FIG. 2. Description of a communication device 100 according to the second example embodiment is the same as the description of the communication device 100 according to the first example embodiment, except for the following description. Hereinafter, description will be given of the communication device 100 according to the second example embodiment regarding a portion different from the communication device 100 according to the first example embodiment, by means of comparison with the communication device 100 according to the first example embodiment. When the following description is inconsistent with the description according to the first example embodiment, the following description is prioritized.

As described above, the communication device 100 according to the first example embodiment derives a transfer degree f for determining transfer propriety of control information, by using a constant R uniformly set for the entire communication system.

In contrast to this, the communication device 100 according to the second example embodiment sets the constant R individually for each communication device 100. Further, control information generated by the communication device 100 according to the second example embodiment includes a device ID, positional information of the communication device 100, a sequence number, and a constant R preliminarily set for the communication device 100. The device ID is a device ID being able to identify the communication device 100 by which the control information is generated. The sequence number is an information ID being able to identify generated control information for at least a certain period of time.

Hereinafter, considering the above, components of the communication device 100 according to the second example embodiment will be described.

As described above, the transfer propriety determination unit 130 according to the first example embodiment receives a device ID of a generation-source communication device, positional information of the generation-source communication device, and an information ID of the control information that are extracted from which control information received by the data transmission/reception unit 120. Then, the transfer propriety determination unit 130 according to the first example embodiment reads out positional information of a neighboring communication device other than the generation-source communication device in which the control information is generated that is stored in the storing unit 150. Then, the transfer propriety determination unit 130 according to the first example embodiment determines whether to transfer the control information, based on these pieces of information.

In contrast to this, a transfer propriety determination unit 130 according to the second example embodiment reads out, from a storing unit 150, information received from a data transmission/reception unit 120, positional information of a neighboring communication device other than a generation-source communication device in which the control information is generated, and a constant R for the neighboring communication device. Then, the transfer propriety determination unit 130 determines whether to transfer the control information, based on these pieces of information.

As described above, when generating control information, the application unit 140 according to the first example embodiment generates control information including positional information acquired from the positional information acquisition unit 160, a device ID of the communication device 100, and a sequence number of the control information. Then, the application unit 140 sends the prepared control information to the data transmission/reception unit 120. Upon receiving control information generated by another communication device, the application unit 140 causes the storing unit 150 to hold positional information of the generation-source communication device included in the control information, together with a device ID of the generation-source communication device and an information ID of the control information.

In contrast to this, when generating control information, an application unit 140 according to the second example embodiment generates the following, in addition to positional information acquired from a positional information acquisition unit 160, a device ID of the communication device 100, and a sequence number of the control information. That is, the application unit 140 generates control information including a constant R preliminarily set for the communication device 100, and inputs the control information to the data transmission/reception unit 120. Upon receiving control information generated by another communication device, the communication device 100 according to the second example embodiment causes the storing unit 150 to store positional information of the generation-source communication device and a constant R for the generation-source communication device included in the control information. The communication device 100 causes the storing unit 150 to store the positional information and the constant R together with a device ID of the generation-source communication device and an information ID of the control information.

As described above, the storing unit 150 according to the second example embodiment holds, in addition to a variety of information stored in the storing unit 150 according to the first example embodiment, a constant R for a transmission-source communication device from which control information is transmitted, in each transmission-source communication device.

### [Processing Flow Example]

A processing flow example of processing performed by the application unit 140 according to the second example embodiment illustrated in FIG. 2 and relating to transmission of control information prepared by the application unit 140 is the same as the processing flow example according to the first example embodiment illustrated in FIG. 3.

However, description of the processing flow example is different from that of the processing flow example according to the first example embodiment in the following point.

The processing flow example illustrated in FIG. 3 according to the second example embodiment is different from the processing flow example illustrated in FIG. 1 according to the first example embodiment in a point that processing of S102 includes the following processing.

In other words, the application unit 140 generates control information including acquired latest positional information, a device ID of the communication device 100, an information ID of the control information, and a constant R preliminarily set for the communication device 100.

Except for the above description, description of processing of S103 according to the second example embodiment is the same as the description of the processing of S103 according to the first example embodiment. When the above description is inconsistent with the description of the processing of S103 according to the first example embodiment, the above description is prioritized.

A processing flow example relating to transfer processing performed in the second example embodiment by the data transmission/reception unit 120 illustrated in FIG. 2 when control information sent from another communication device is received is the same as the processing flow according to the first example embodiment illustrated in FIG. 4. However, description of the processing flow according to the second example embodiment is different from the description of the processing flow according to the first example embodiment in the following point.

A difference between the descriptions is the following portion relating to processing of S202 in the processing flow.

The application unit 140 extracts positional information, a device ID, a constant R, and a sequence number of control information that are included in the control information included in received data, and causes the storing unit 150 to hold the positional information, the device ID, the constant R, and the sequence number. The positional information is positional information of a generation-source communication device in which the control information is generated. The device ID is a device ID of the generation-source communication device in which the control information is generated. The constant R is a constant R preliminarily set for the generation-source communication device in which the control information is generated. The sequence number is an information ID of the control information.

Except for the above description, description of the processing of S202 according to the second example embodiment is the same as the description of the processing of S202 according to the first example embodiment. When the above description is inconsistent with the description of the processing of S202 according to the first example embodiment, the above description is prioritized.

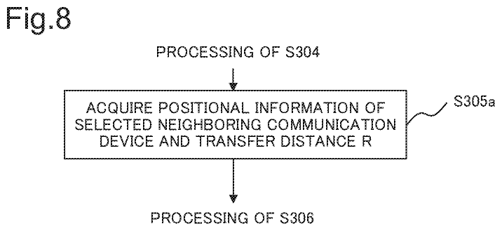

A processing flow example of processing performed by the transfer propriety determination unit 130 illustrated in FIG. 2 according to the second example embodiment is a processing flow in which the processing of S305 illustrated in FIG. 5 is replaced with processing of S305a illustrated in FIG. 8.

FIG. 8 is a conceptual diagram illustrating processing with which the processing of S305 illustrated in FIG. 5 is replaced.

Description of the processing flow according to the second example embodiment to which the replacement is applied is different from the description of the processing flow according to the first example embodiment illustrated in FIG. 5 in the following point. Except for the following description, the description of the processing flow to which the replacement is applied according to the second example embodiment is the same as the description of the processing flow according to the first example embodiment illustrated in FIG. 5. When the following description is inconsistent with the description according to the first example embodiment, the following description is prioritized.

Description about processing of S304, S305a, and S306 is different from the first example embodiment in a point as follows.

The processing of S304 is followed by the processing of S305a.

When performing the processing of S305a, the transfer propriety determination unit 130 acquires, as the processing, latest positional information of a neighboring communication device selected in the processing of S304, from the storing unit 150 illustrated in FIG. 3. Further, the transfer propriety determination unit 130 acquires, as the processing, a constant R for the neighboring communication device from the storing unit 150. As described in the description according to the first example embodiment, a neighboring communication device periodically transmits control information. Thus, the storing unit 150 holds positional information of a neighboring communication device and a constant R for the neighboring communication device. Thus, the transfer propriety determination unit 130 can acquire, from the storing unit 150, latest positional information of a selected neighboring communication device and a constant R for the selected neighboring communication device.

The processing of S305a is followed by the processing of S306.

Description about processing of S307 is different from the first example embodiment in a point as follows.

When performing the processing of S307, the transfer propriety determination unit 130 calculates, as the processing, a transfer degree f, based on the constant R acquired in the processing of S305a and a distance d derived in the processing of S306.

Except for the above description, the description of S307 according to the second example embodiment is the same as the description of S307 according to the first example embodiment.

### [Advantageous Effect]

A transfer system according to the present example embodiment individually sets a constant R for each communication device. In other words, this means that a range influenced in the case of determining formation of communication devices can be determined according to an attribute such as a movement speed of each of the communication devices. Accordingly, the transfer system enables further improvement of optimality relating to formation of a communication device group, in addition to the advantageous effect exhibited by the transfer system according to the first example embodiment.

### Third Example Embodiment

A third example embodiment is an example embodiment relating to a communication device that transfers received control information to another communication device through multicasting or broadcasting.

### [Configuration and Operation]

An example of a communication system according to the third example embodiment is the same as the communication system 1 illustrated in FIG. 1. Description of a communication system 1 according to the second example embodiment is the same as the description of the communication system 1 according to the first example embodiment illustrated in FIG. 1, except for the following description about communication devices.

An example of a communication device according to the third example embodiment is the same as the communication device 100 illustrated in FIG. 2. Description of a communication device 100 according to the third example embodiment is the same as the description of the communication device 100 according to the second example embodiment, except for the following description. Hereinafter, description will be given of the communication device 100 according to the third example embodiment regarding a portion different from the communication device 100 according to the second example embodiment, by means of comparison with the communication device 100 according to the second example embodiment. When the following description is inconsistent with the description according to the second example embodiment, the following description is prioritized.

As described above, when transferring control information, the communication device 100 according to the second example embodiment transfers control information to a neighboring communication device 100 by using unicasting. In contrast to this, when transferring control information, the communication device 100 according to the third example embodiment transfers control information by using broadcasting or multicasting. Hereinafter, considering the above, components of the communication device 100 will be described.

When transferring control information to a neighboring communication device, the data transmission/reception unit 120 according to the second example embodiment transfers, through unicasting, control information to each neighboring communication device being a transfer target.

In contrast to this, when transferring control information to a neighboring communication device, a data transmission/reception unit 120 according to the third example embodiment transfers control information to all neighboring communication devices at once by using broadcasting or multicasting. As such a transfer method, a so-called flooding approach being a well-known art is available. At that time, the data transmission/reception unit 120 may use MPR in OLSR being the above-described well-known routing protocol, and may prevent duplication of control information. Except for the above description, the data transmission/reception unit 120 according to the third example embodiment is the same as the data transmission/reception unit 120 according to the second example embodiment, and thus, will not be described.

The transfer propriety determination unit 130 according to the second example embodiment acquires a device ID of a generation-source communication device from which control information received by the data transmission/reception unit 120 is generated, positional information of the generation-source communication device, and a sequence number being an information ID of the control information that are extracted from the control information. Then, the transfer propriety determination unit 130 according to the second example embodiment reads out positional information of a neighboring communication device other than a transmission-source communication device from which the control information is transmitted and a constant R for the neighboring communication device that are held by the storing unit 151 . Then, the transfer propriety determination unit 130 according to the second example embodiment determines, based on these pieces of information, whether to transfer the control information, regarding each of neighboring communication devices being transfer candidates.

In contrast to that, a transfer propriety determination unit 130 according to the third example embodiment acquires information received from the data transmission/reception unit 120, positional information of a neighboring communication device other than a transmission-source communication device from which the control information is transmitted, and a constant R for the neighboring communication device that are stored in the storing unit 150. Then, the transfer propriety determination unit 130 according to the third example embodiment calculates, based on these pieces of information, a transfer degree f for each neighboring communication device being a transfer candidate. Then, the transfer propriety determination unit 130 according to the third example embodiment determines whether to transfer the control information through broadcasting or multicasting, with the smallest transfer degree f among transfer degrees f for the neighboring communication devices as a reference. The smallest transfer degree f means transfer of control information to a neighboring communication device relating to the transfer degree f is performed most frequently.

Except for the above description, description of the transfer propriety determination unit 130 according to the third example embodiment is the same as the description of the transfer propriety determination unit 130 according to the second example embodiment.

### [Processing Flow Example]

A processing flow example of processing performed by an application unit 140 according to the third example embodiment illustrated in FIG. 2 and relating to transmission of control information generated by the application unit 140 is the same as the processing flow according to the second example embodiment illustrated in FIG. 3.

However, description of the processing flow example is different from that of the processing flow example according to the second example embodiment in the following point.

The processing flow illustrated in FIG. 3 according to the third example embodiment is different from the processing flow illustrated in FIG. 3 according to the second example embodiment in the following point about processing of S104.

Specifically, the data transmission/reception unit 120 reads out transmission data being data to be transmitted that is in the head of a transmission buffer for performing processing of transmitting control information and content data in order. The transmission data is control information or content data. The data transmission/reception unit 120 transmits the read-out transmission data to a neighboring communication device being a transmission target via a communication unit 110. When the read-out transmission data is control information, the data transmission/reception unit 120 transmits the control information by using broadcasting or multicasting. When the read-out transmission data is content data, the data transmission/reception unit 121 transmits the content data through any of unicasting, broadcasting, and multicasting, according to a transmission destination of the content data.

Except for the above description, description of the processing of S104 according to the second example embodiment is the same as the description of the processing of S104 according to the second example embodiment. When the above description is inconsistent with the description of the processing of S104 according to the second example embodiment, the above description is prioritized.

A processing flow example relating to transfer processing performed by the data transmission/reception unit 120 illustrated in FIG. 2 when control information sent from another communication device is received according to the third example embodiment is the same as the processing flow according to the second example embodiment illustrated in FIG. 4. However, description of the processing flow according to the third example embodiment is different from the description of the processing flow according to the second example embodiment in a point that processing of S206 in the processing flow includes the following processing.

When performing the processing of S206, the data transmission/reception unit 120 transfers, as the processing, control information determined as being included in received data in processing of S203, through broadcasting or multicasting via the communication unit 110 illustrated in FIG. 2.

Except for the above description, description of the processing of S206 according to the second example embodiment is the same as the description of the processing of S206 according to the first example embodiment. When the above description is inconsistent with the description of the processing of S206 according to the second example embodiment, the above description is prioritized.

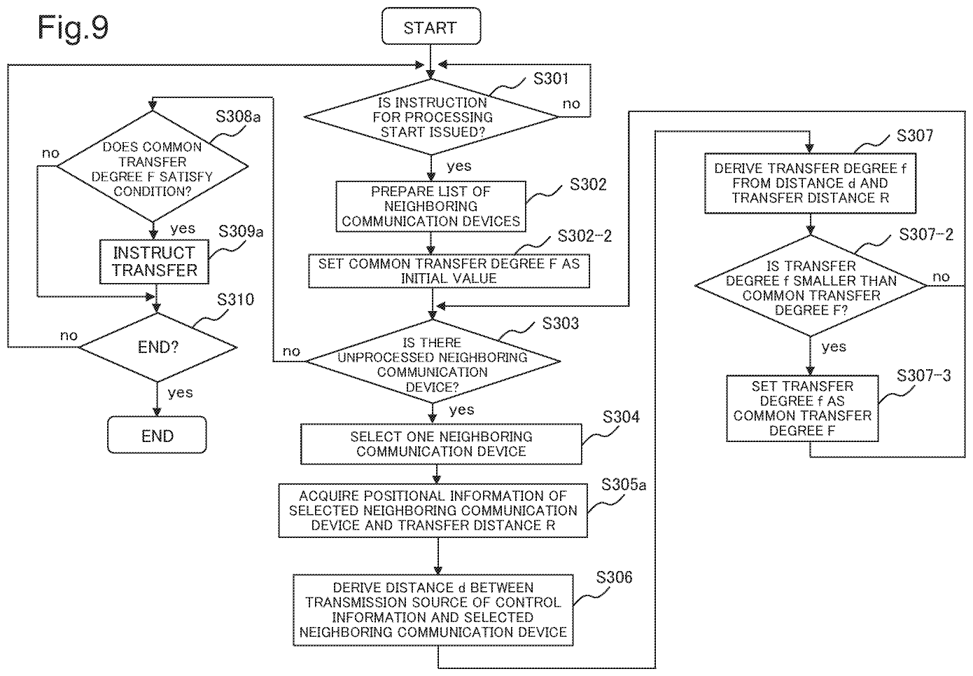

FIG. 9 is a conceptual diagram illustrating a processing flow example of processing performed by the transfer propriety determination unit 130 according to the third example embodiment illustrated in FIG. 3.

Description about start, processing of S301 to S304, S305a, S306, S307, and S310, and end illustrated in FIG. 9 is the same as the description of the processing and the like according to the second example embodiment illustrated in FIGS. 5 and 8. Hereinafter, description will be given of the processing flow illustrated in FIG. 9, regarding a portion different from the processing according to the second example embodiment.

The transfer propriety determination unit 130 according to the third example embodiment performs processing of S302 followed by processing of S302-2.

When performing the processing of S302-2, the transfer propriety determination unit 130 sets, as the processing, a common transfer degree F. as an initial value. Herein, the common transfer degree F. is used in processing of S308a described later. A term common in a common transfer degree means that the common transfer degree is applied commonly to neighboring devices in a list prepared in the processing of S302. It is assumed that the initial value of the common transfer degree F. is supposed to be sufficiently large in comparison with a normally derived transfer degree f.

Description of the processing of S303, S304, S305a, S306, and S307 is the same as the processing according to the second example embodiment as described above, and thus, will not be given.

The transfer propriety determination unit 130 according to the third example embodiment performs the processing of S307 followed by processing of S307-2.

When performing the processing of S307-2, the transfer propriety determination unit 130 performs, as the processing, determination as to whether a transfer degree f derived in the processing of S307 is smaller than the common transfer degree F. As described above, a sufficiently large value is set for the common transfer degree F. as an initial value. Thus, in the first processing of S307-2 after the processing of S302-2, it is determined that the transfer degree f is smaller than the common transfer degree F.

When a determination result in the processing of S307-2 is yes, the transfer propriety determination unit 130 performs processing of S307-3.

Meanwhile, when a determination result in the processing of S307-2 is no, the transfer propriety determination unit 130 according to the third example embodiment performs the processing of S303 again.

When performing the processing of S307-3, the transfer propriety determination unit 130 according to the third example embodiment sets, as the processing, the transfer degree f derived in the processing of S307 as a common transfer degree F. Then, the transfer propriety determination unit 130 according to the third example embodiment performs the processing of S303 again.

When a determination result in the processing of S303 is no, the transfer propriety determination unit 130 according to the third example embodiment performs the processing of S308a.

When performing the processing of S308a, the transfer propriety determination unit 130 according to the third example embodiment performs, as the processing, determination as to whether the common transfer degree F. satisfies a condition.

The condition is that, for example, division of a sequence number s being an information ID of the control information by the common transfer degree F. leaves a remainder of zero. Accordingly, it is determined that the condition is satisfied once every F times.

When a determination result in the processing of S308a is yes, the transfer propriety determination unit 130 according to the third example embodiment performs processing of S309a.

Meanwhile, when a determination result in the processing of S308a is no, the transfer propriety determination unit 130 according to the third example embodiment performs the processing of S310.

When performing the processing of S309a, the transfer propriety determination unit 130 according to the third example embodiment instructs the transfer propriety determination unit 130 to transmit control information sent by the transfer propriety determination unit 130 when the transfer propriety determination unit 130 performs processing of S204 illustrated in FIG. 4. The transmission is transmission through broadcasting or multicasting. Herein, in the case of the transmission through multicasting, the transfer propriety determination unit 130 assumes, when performing the instruction, that neighboring communication devices in a list prepared in the last processing of S302 are included in a certain multicast group, and designates a multicast address of the group as a transmission-destination address. In the case of the transmission through broadcasting, designation of a transmission destination is unnecessary.

Then, the transfer propriety determination unit 130 according to the third example embodiment performs the processing of S310. Description of S310 is the same as the description of S310 according to the second example embodiment illustrated in FIG. 5.

### [Advantageous Effect]

The communication system according to the third example embodiment enables reduction in traffic amount of control information according to a distance from a generation-source communication device in which the control information is generated, even when the control information is transmitted through broadcasting or multicasting. When control information is transmitted through broadcasting or multicasting, individual communication devices may possibly receive the control information with frequency higher than control information reception frequency determined on the basis of a proper transfer degree. However, broadcasting or multicasting enables batch transmission to a plurality of neighboring communication devices. Accordingly, the communication system enables more efficient transfer of control information, in addition to the advantageous effect exhibited by the communication system according to the second example embodiment.

The above description of the communication system according to the present example embodiment and a portion thereof is based on the description of the communication system according to the second example embodiment and a portion thereof. Further, the description of the communication system according to the second example embodiment and a portion thereof is based on the description of the communication system according to the first example embodiment and a portion thereof. Therefore, the communication system according to the present example embodiment and a portion thereof can be achieved by the communication system according to the first example embodiment and a portion thereof.

Regarding the data transmission/reception unit 120 according to the above-described first to third example embodiments, an example has been described in which control information and content data to be transmitted are written in an identical transmission buffer and, in the case of transmission, control information and content data is read out sequentially from the head of the transmission buffer and are transmitted. However, data transmission processing may be transmission in order of higher priority according to priority appropriately given to control information and content data to be transmitted, such as, for example, preferential transmission of control information.

Regarding the transfer propriety determination unit 130 according to the above-described first to third example embodiments, an example has been described in which a transfer degree f is calculated by using the expression (2). However, as the transfer degree f, a transfer degree f may be used that is preliminarily determined fixedly for a distance d between a generation-source communication device in which control information is generated and a neighboring communication device, and a constant R. A way of determination includes, for example, f=1 in the case of 0≤d/R<1, f=2 in the case of 1≤d/R<3, f=16 in the case of 3≤d/R, and the like. A transfer degree f is determined in such a way that f becomes larger as a distance d becomes larger. Thus, a method of calculating a transfer degree f is not limited to the expression (2) as long as the calculation method is capable of tinning control information to be transferred and reducing traffic amount. The communication device according to the example embodiment may transfer control information with a temporarily higher transfer probability or temporarily lower transfer probability than a transfer probability derived by using a transfer degree or the like. The communication system according to the example embodiment may be any communication system capable of achieving average reduction in traffic amount.

Regarding control information prepared by the communication device according to the above-described first to third example embodiments, an example has been described in which a sequence number is used as an information ID of control information. However, an information ID of control information is not limited to a sequence number. For example, by including time information or the like in control information, the control information can be also identified by using the time information as an information ID. In that case, however, the above-described determination method cannot be used in which transfer is performed when a sequence number divided by a transfer degree f leaves a remainder of zero. Instead, a method is applicable in which the number of pieces of control information not previously transferred to the storing unit is counted from the number of pieces of transferred control information for each generation-source communication device in which control information is generated, and transfer propriety is determined according to the counted value.

Furthermore, regarding the data transmission/reception unit 120 according to the above-described first to third example embodiments, an example has been described in which, when receiving control information generated by another communication device, the data transmission/reception unit 120 inquires of the transfer propriety determination unit 130 whether to transfer the control information to another neighboring communication device. Then, an example has been described in which the data transmission/reception unit 120 according to the first to third example embodiments performs transfer, based on a result of inquiry. However, by inquiring of the transfer propriety determination unit 130 at a time of first transfer of control information generated by the communication device 100, even a generation-source communication device in which control information is generated can transfer the generated control information according to a transfer degree.

In addition to the above description, each component of the communication device 100 according to the above-described example embodiments may be configured by a semiconductor processing part including an application specific integrated circuit (ASIC). These components may be achieved by causing a computer system including at least one processor (for example, a microprocessor) and a DSP to execute a program. Herein, the microprocessor is a micro processing unit (MPU). A DSP is an abbreviation of a digital signal processor.

Specifically, one or a plurality of program(s) including instructions for causing a computer system to perform an algorithm relating to transmission signal processing or reception signal processing performed by the data transmission/reception unit 120, the transfer propriety determination unit 130, the application unit 140, and the storing unit 150 is/are prepared. Then, the program(s) may be executed by a computer.

The program(s) may be provided for a computer by being stored in various types of non-transitory computer readable media. A non-transitory computer readable medium includes various types of recording media (tangible storage media).

A non-transitory computer readable medium is, for example, a magnetic recording medium (for example, a flexible disk, a magnetic tape, and a hard disk), a magneto-optical recording medium (for example, a magneto-optical disk), a CD-ROM, or a CD-R. Herein, a CD-ROM is an abbreviation of a compact disc-read only memory. A CD-R is an abbreviation of a compact disc-recordable.

Alternatively, a non-transitory computer readable medium is, for example, a CD-R/W or a semiconductor memory. Herein, a CD-R/W is an abbreviation of a compact disc-rewritable. A semiconductor memory is, for example, a mask ROM, a programmable ROM (PROM), or an erasable PROM (EPROM).

Alternatively, a non-transitory computer readable medium is, for example, a Flash ROM and a random access memory (RAM).

A program may be provided for a computer by various types of transitory computer readable media. A transitory computer readable medium is, for example, an electrical signal, an optical signal, and an electromagnetic wave. A transitory computer readable medium can provide a program for a computer via, for example, a wired communication path such as an electrical wire or an optical fiber, or via a wireless communication path.

The above-described example embodiments are not limited to the above description, and a change may be made therein as appropriate without departing from the spirit.

The above-described example embodiments are merely examples relating to application of a technical idea acquired by the present inventor. In other words, it is obvious that the technical idea is not limited to only the above-described example embodiments and various changes may be made therein.

### Fourth Example Embodiment

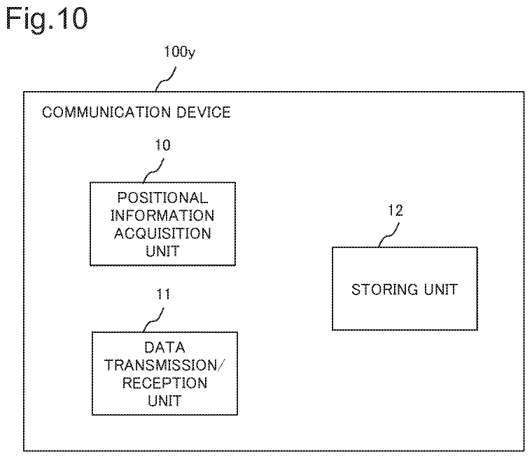

FIG. 10 is a block diagram illustrating a configuration of a communication device 100y being an example of a communication device according to a fourth example embodiment.

The communication device 100y includes a positional information acquisition unit 10, a data transmission/reception unit 11, and a storing unit 12.

The positional information acquisition unit 10 is, for example, the positional information acquisition unit 160 illustrated in FIG. 2. The data transmission/reception unit 11 is, for example, a combination of the communication unit 110, the data transmission/reception unit 120, and the transfer propriety determination unit 130 illustrated in FIG. 2. The storing unit 12 is, for example, the storing unit 150 illustrated in FIG. 2.

Upon request from the data transmission/reception unit 11 for acquisition of positional information, the positional information acquisition unit 10 acquires positional information (for example, a GPS) of the communication device 100y at that time, and notifies the data transmission/reception unit 11 of the positional information.

The data transmission/reception unit 11 generates control information described in the first to third example embodiments at preliminarily set time intervals, and transfers the control information to a neighboring communication device. Further, upon receiving control information generated by another neighboring communication device, the data transmission/reception unit 11 extracts a variety of information included in the received control information. The variety of information includes a device ID of a generation-source communication device, positional information of the generation-source communication device, an information ID of the control information, and a constant R. The data transmission/reception unit 11 causes the storing unit 12 to store the device ID, the positional information, the information ID, and the constant R. Then, the data transmission/reception unit 11 determines whether to transfer the received control information to another neighboring communication device. The data transmission/reception unit 11 calculates a transfer degree f, based on the positional information of the generation-source communication device in which the received control information is generated, a distance d calculated from positional information of a transmission-destination communication device held by the storing unit 12, and a preliminarily set constant R, and performs the determination according to a value of the transfer degree f.

The storing unit 12 stores the above-described device ID of the generation-source communication device, the above-described positional information of the generation-source communication device, the above-described information ID of the control information, and the above-described constant R that are extracted from the received control information.

When transferring control information generated by each communication device to another communication device within a communication system, the communication device 100y determines whether to transmit the control information, based on a transfer degree according to a distance between a generation-source communication device in which the control information is generated and a communication device being a transmission destination. Consequently, every time control information is generated, the control information is transferred to a communication device at a close distance from a generation-source communication device in which the control information is generated. However, as the distance becomes farther, transmission destinations to which the control information is transferred are reduced according to a transfer degree, in a communication device through which the control information passes during transfer.

Thus, when a plurality of communication devices 100y accomplish a given operation while autonomously performing a collaborative operation, traffic amount relevant to exchange of a variety of information necessary for a control algorithm achieving the autonomous collaborative operation is reduced. Accordingly, the communication device 100y enables reduction in transfer delay of information necessary to be exchanged, and enables ensuring a bandwidth necessary for another information communication.

A configuration example of a hardware resource that achieves the communication device according to the above-described example embodiments of the present invention by using one information processing device (computer) will be described. The communication device may be achieved by using physically or functionally at least two information processing devices. The communication device may be achieved as a dedicated device. Only some of functions of the communication device may be achieved by using an information processing device.

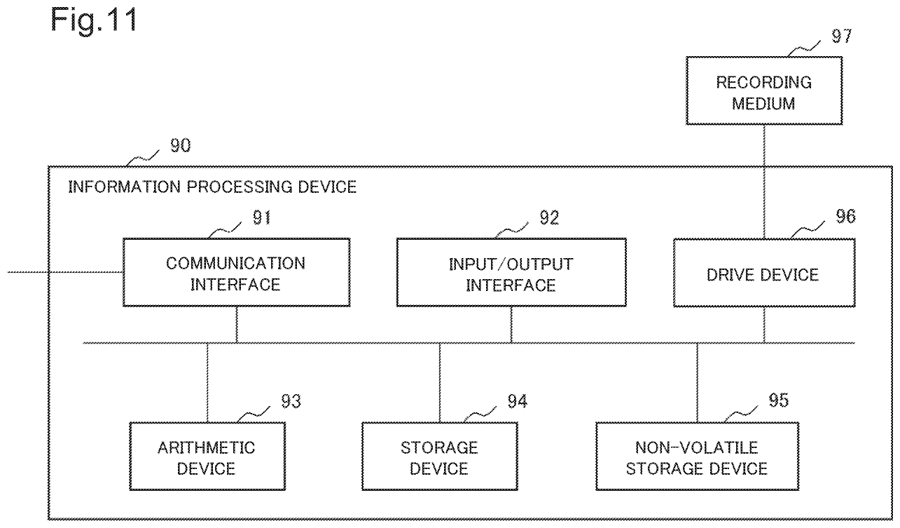

FIG. 11 is a conceptual diagram illustrating a hardware configuration example of an information processing device capable of achieving the communication device according to the example embodiments of the present invention. An information processing device 90 includes a communication interface 91, an input/output interface 92, an arithmetic device 93, a storage device 94, a non-volatile storage device 95, and a drive device 96.

The communication interface 91 is a communication means by which the communication device according to the example embodiments communicates with an external device wiredly or/and wirelessly. When the communication device is achieved by using at least two information processing devices, these devices may be connected to each other in such a way as to be mutually communicable via the communication interface 91.

The input/output interface 92 is a man-machine interface such as a keyboard being one example of an input device, and a display as an output device.

The arithmetic device 93 is an arithmetic processing device such as a general-purpose central processing unit (CPU) and a microprocessor. The arithmetic device 93 may read out, for example, a variety of programs stored in the non-volatile storage device 95 into the storage device 94, and may execute processing according to the read-out programs.

The storage device 94 is a memory device such as a random access memory (RAM) that can be referred to from the arithmetic device 93, and stores a program, a variety of data, and the like. The storage device 94 may be a volatile memory device.

The non-volatile storage device 95 is, for example, a non-volatile storage device such as a read only memory (ROM) and a flash memory, and can store a variety of programs, data, and the like.

The drive device 96 is, for example, a device that processes reading and writing of data from and in a recording medium 97 described later.

The recording medium 97 is, for example, any recording medium capable of recording data, such as an optical disk, a magneto-optical disk, and a semiconductor flash memory.

The example embodiments according to the present invention may be achieved by, for example, configuring a communication device by using the information processing device 90 exemplified in FIG. 11, and supplying the communication device with a program capable of implementing a function described in the above-described example embodiments.

In this case, the example embodiments can be achieved by the arithmetic device 93 executing the program supplied for the communication device. Some, but not all, of functions of the communication device can be also configured by using the information processing device 90.

Furthermore, configuration may be made in such a way that the above-described program is recorded in the recording medium 97, and the above-described program is stored in the non-volatile storage device 95 as appropriate in a shipment stage, an operational stage, or the like of the communication device. In this case, a method of supplying the above-described program may employ a method of installing the above-described program on the communication device by using an appropriate jig in a manufacture stage before shipment, an operational stage, or the like. Further, a method of supplying the above-described program may employ a general procedure, such as a method of downloading the above-described program externally via a communication line such as the Internet.

The example embodiments described above are preferred example embodiments of the present invention, and various changes may be made therein without departing from the spirit of the present invention.

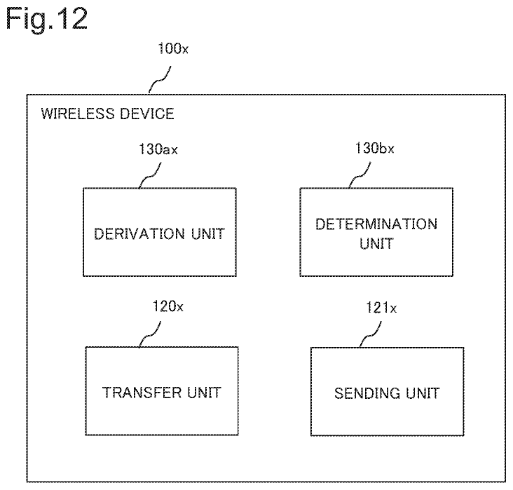

FIG. 12 is a block diagram illustrating a configuration of a wireless device 100x being a minimum configuration according to the example embodiments.

The wireless device 100x includes a derivation unit 130ax, a determination unit 130bx, a transfer unit 120x, and a sending unit 121x.

The derivation unit 130ax derives a distance between the generation-source wireless device and the candidate wireless device from a first position and a second position. Herein, the first position is a position of the generation-source wireless device, included in sent first control information. The second position is a position of a candidate wireless device being a candidate for a device to which the first control information is transferred, included in second control information sent by the candidate wireless device.

The determination unit 130bx calculates, by using a predetermined function that exhibits a tendency to decrease with an increase of the distance and always takes a positive value, a probability of transferring the first control information to the candidate wireless device.

The transfer unit 120x performs the transfer based on the probability.

The sending unit 121x sends the first control information and the second control information to a movement control unit that controls autonomous movement by using the first control information and the second control information.

As described in the paragraphs of Technical Problem, in order to ensure the above-described optimality in the case of using communication devices, it is important that a probability that control information generated by any communication device reaches each of the communication devices does not become zero. In order to reduce a traffic load relating to exchange of control information necessary for control of individual communication devices to autonomously perform a collaborative operation, it is effective that, as a distance d increases, a probability that control information reaches each unmanned vehicle decreases.

The wireless device 100x determines a probability of transferring the first control information to the candidate wireless device, based on the distance between the generation-source wireless device and the candidate wireless device. The probability exhibits a tendency to decrease when the distance increases, although does not becomes zero. A degree of the decrease as the distance increases may be adjusted by substituting the distance divided by a predetermined numerical value regulating the degree into the function, and the like.

Therefore, the wireless device 100x is capable of reducing a traffic load relating to exchange of control information necessary for control of individual unmanned vehicles to autonomously perform a collaborative operation, while ensuring the above-described optimality in the case of using a plurality of unmanned vehicles.

Thus, with the configuration, the wireless device 100x exhibits the advantageous effect described in the paragraphs of [Advantageous Effects of Invention].

The wireless device 100x illustrated in FIG. 12 is, for example, the communication devices 101 to 10n illustrated in FIG. 1, the communication device 100 illustrated in FIG. 2, and the communication device 100y illustrated in FIG. 10.

The derivation unit 130ax is, for example, a portion deriving a distance between the generation-source wireless device and the candidate wireless device, in the transfer propriety determination unit 130 illustrated in FIG. 2.

The determination unit 130bx is, for example, a portion calculating a probability of transferring the first control information to the candidate wireless device by using the function, in the transfer propriety determination unit 130 illustrated in FIG. 2.

The transfer unit 120x is, for example, a portion performing the transfer based on the probability, in the data transmission/reception unit 120 and the communication unit 110 illustrated in FIG. 2.

The sending unit 121x is, for example, a portion performing sending of the first control data and the second control data to the movement control unit 171, in the data transmission/reception unit 120 illustrated in FIG. 2.

A sentence “exhibits a tendency to decrease with an increase of the distance” described above means that there may be a range of the distance within which a function value relating to the function increases along with an increase of the distance, but overall, the function value tends to decrease. For example, a case in which performing some kind of smoothing processing on the function results in a function after the smoothing processing that decreases with an increase of the distance is included in a case in which a function exhibits a tendency to decrease with an increase of the distance. The smoothing processing includes, for example, processing of deriving a spline curve or a B-spline curve for a predetermined number of function values of the function.

While the example embodiments of the present invention have been described, the present invention is not limited to the above-described example embodiments, and further modification, replacement, and adjustment may be added without departing from the basic technical idea of the present invention. For example, configurations of elements illustrated in the drawings are examples for helping understanding of the present invention, and there is no intention to limit the present invention to the configurations illustrated in the drawings.

Some or all of the above-described example embodiments can be described as the following supplementary notes, but are not limited to the following.

### (Supplementary Note 1)

A wireless device including:

a derivation unit that derives, from a first position that is included in sent first control information and is a position of a generation-source wireless device in which the first control information is generated, and a second position that is included in second control information to be sent by a candidate wireless device being a candidate for a device to which the first control information is transferred and is a position of the candidate wireless device, a distance between the generation-source wireless device and the candidate wireless device;

a determination unit that calculates, by using a predetermined function that exhibits a tendency to decrease with an increase of the distance and always takes a positive value, a probability of transferring the first control information to the candidate wireless device;

a transfer unit that performs the transfer based on the probability; and

a sending unit that sends the first control information and the second control information to a movement control unit that controls autonomous movement by using the first control information and the second control information.

### (Supplementary Note 2)

The wireless device according to supplementary note 1, wherein the function asymptotically approaches zero with an increase of the distance.

### (Supplementary Note 3)

The wireless device according to supplementary note 1 or 2, wherein the function is in proportion to, relating to a value acquired by subtracting 1 from a minimum integer equal to or more than a number of the distance divided by a predetermined constant, a reciprocal of 2 raised to a power of the value.

### (Supplementary Note 4)

The wireless device according to supplementary note 2 or 3, wherein the function is in proportion to a second function, and a proportionality constant relating to the proportion is unique for each of the candidate wireless devices.

### (Supplementary Note 5)

The wireless device according to any one of supplementary notes 1 to 4, wherein the candidate wireless device is a neighboring wireless device to which the first control information can be sent wirelessly without passing through another wireless device.

### (Supplementary Note 6)

The wireless device according to any one of supplementary notes 1 to 5, wherein the transfer is performed through unicasting.

### (Supplementary Note 7)

The wireless device according to any one of supplementary notes 1 to 5, wherein the transfer is performed through broadcasting or multicasting.

### (Supplementary Note 8)

The wireless device according to supplementary note 7, wherein the transfer is performed according to a maximum value of the probability derived for each of a plurality of the candidate wireless devices.

### (Supplementary Note 9)

The wireless device according to supplementary note 8, wherein the transfer is performed according to a maximum value of the probability derived for each of all of the candidate wireless devices.

### (Supplementary Note 10)

The wireless device according to any one of supplementary notes 1 to 5, wherein, when the transfer is performed, the transfer through multicasting is performed for all of the candidate wireless devices.

### (Supplementary Note 11)

The wireless device according to any one of supplementary notes 1 to 10, wherein the first control information includes, in addition to the first position, a device ID of the generation-source wireless device and an information ID of the first control information.

### (Supplementary Note 12)

The wireless device according to any one of supplementary notes 1 to 11, wherein the second control information includes, in addition to the second position, a device ID of the candidate wireless device and an information ID of the second control information.

### (Supplementary Note 13)

A wireless system including a plurality of the wireless devices according to any one of supplementary notes 1 to 12.

### (Supplementary Note 14)

A communication method including:

deriving, from a first position that is included in sent first control information and is a position of a generation-source wireless device in which the first control information is generated, and a second position that is included in second control information to be sent by a candidate wireless device being a candidate for a device to which the first control information is transferred and is a position of the candidate wireless device, a distance between the generation-source wireless device and the candidate wireless device;

calculating, by using a predetermined function that exhibits a tendency to decrease with an increase of the distance and always takes a positive value, a probability of transferring the first control information to the candidate wireless device;

performing the transfer based on the probability; and

sending the first control information and the second control information to a movement control unit that controls autonomous movement by using the first control information and the second control information.

### (Supplementary Note 15)

The communication method according to supplementary note 14, wherein the derivation, the calculation, and the transfer are performed when autonomous movement is performed.

### (Supplementary Note 16)

A communication program that causes a computer to execute: processing of deriving, from a first position that is included in sent first control information and is a position of a generation-source wireless device in which the first control information is generated, and a second position that is included in second control information to be sent by a candidate wireless device being a candidate for a device to which the first control information is transferred and is a position of the candidate wireless device, a distance between the generation-source wireless device and the candidate wireless device;

processing of calculating, by using a predetermined function that exhibits a tendency to decrease with an increase of the distance and always takes a positive value, a probability of transferring the first control information to the candidate wireless device;

processing of performing the transfer based on the probability; and

processing of sending the first control information and the second control information to a movement control unit that controls autonomous movement by using the first control information and the second control information.

### (Supplementary Note 17)

An information transfer method that wirelessly transfers information between each pair of a plurality of communication devices, the information transfer method including:

a step of acquiring positional information of an own communication device being the communication device being a target; and

a data transmission/reception step of performing the transfer by generating set information including at least a device ID identifying the own communication device, acquired positional information, and an information ID identifying the positional information, and performing the transfer of the set information, as transfer target information, being received from a neighboring communication device with which direct wireless communication is possible and generated by another of the communication devices, to a neighboring communication device other than a transmission destination of the information, wherein

the data transmission/reception step includes:

calculating, from the positional information that is included in the transfer target information and relating to a generation-source communication device being the communication device as a generation source of the transfer target information, and the positional information that is notified from a transmission-destination neighboring communication device being the neighboring communication device as a transmission destination of the transfer target information, an inter-communication-device distance being a distance between the generation-source communication device and the transmission-destination neighboring communication device;

deriving, based on the inter-communication-device distance and a preliminarily set constant, a probability of performing the transfer of the transfer target information to a neighboring communication device; and

performing, based on the probability, the transfer of the transfer target information to the transmission-destination neighboring communication device.

### (Supplementary Note 18)

The information transfer method according to supplementary note 17, wherein the transfer target information includes the set information received from the neighboring communication device and generated by another of the communication devices, and the set information generated by the own communication device.

### (Supplementary Note 19)

The information transfer method according to supplementary note 17 or 18, wherein a transfer degree representing a transfer rate of the transfer target information is calculated by using the inter-communication-device distance and the constant, and the derivation is performed by using the transfer degree.

### (Supplementary Note 20)

The information transfer method according to supplementary note 19, wherein the constant is set individually for each of the communication devices.

### (Supplementary Note 21)

The information transfer method according to supplementary note 19 or 20, wherein the transfer is performed according to the transfer degree at equal intervals from a series of the transfer target information generated by each of the communication devices.

### (Supplementary Note 22)

The information transfer method according to any of supplementary notes 19 to 21, wherein the transfer degree is set to such a value that indicates the transfer of the transfer target information with high frequency when the inter-communication-device distance is shorter than the constant, and indicates the transfer of the transfer target information with low frequency when the inter-communication-device distance is longer than the constant.

### (Supplementary Note 23)

The information transfer method according to any of supplementary notes 19 to 22, wherein,

when the transfer of the transfer target information to the transmission-destination neighboring communication device is performed, whether to perform the transfer is determined based on the highest probability among the probabilities derived for each of the transmission-destination neighboring communication devices, and,

according to a result of the determination, the transfer of the transfer target information to each of the transmission-destination neighboring communication devices is performed by using broadcasting or multicasting.

### (Supplementary Note 24)

An information transfer device being a communication device that wirelessly transfers information between each pair of a plurality of the communication devices, the information transfer device including:

a positional information acquisition means for acquiring positional information of an own communication device; and

a data transmission/reception means for performing the transfer by generating set information including at least a device ID identifying the own communication device, acquired positional information, and an information ID identifying the set information, and performing the transfer of the set information, as transfer target information, being received from a neighboring communication device being the communication device with which direct wireless communication is possible and generated by another of the communication devices, to the neighboring communication device other than a transmission destination of the set information, wherein

the data transmission/reception means

calculates, from the positional information that is included in the transfer target information and representing a position of a generation-source communication device being a generation source of the set information, and the positional information that is notified from a transmission-destination neighboring communication device to which the transfer target information is transferred, an inter-communication-device distance between the generation-source communication device and the neighboring communication device being a transmission destination relating to the transfer;

derives, based on the inter-communication-device distance and a preliminarily set constant, a probability of performing the transfer of the transfer target information to the neighboring communication device; and

performs, based on the probability, the transfer of the transfer target information to the transmission-destination neighboring communication device, and

the information transfer device is the own communication device.

### (Supplementary Note 25)

An information transfer system including a plurality of the communication devices according to supplementary note 24.

### (Supplementary Note 26)

A program for information transfer that causes a computer to execute:

processing of acquiring positional information of an own communication device being a communication device that wirelessly transfers information between each pair of a plurality of the communication devices; and

data transmission/reception processing of performing transfer by generating set information including at least a device ID identifying the own communication device, acquired positional information, and an information ID identifying the set information, and performing the transfer of the set information, as transfer target information, being received from a neighboring communication device being the communication device with which direct wireless communication is possible and generated by another of the communication devices, to the neighboring communication device other than a transmission destination of the set information, wherein

the data transmission/reception processing includes:

processing of calculating, from the positional information that is included in the transfer target information and relating to a generation-source communication device being the communication device as a generation source of the set information, and the positional information that is notified from the neighboring communication device being a transmission destination of the transfer target information, an inter-communication-device distance between the generation-source communication device in which the transfer target information is generated and the neighboring communication device being the transmission destination;

processing of deriving, based on the inter-communication-device distance and a preliminarily set constant, a probability of performing the transfer of the transfer target information to the neighboring communication device; and

processing of performing, based on the probability, the transfer of the transfer target information to the neighboring communication device being the transmission destination.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-223378, filed on Nov. 21, 2017, the disclosure of which is incorporated herein in its entirety by reference.

### REFERENCE SIGNS LIST

1 Communication system
90 Information processing device
91 Communication interface
92 Input/output interface
93 Arithmetic device
94 Storage device
95 Non-volatile storage device
96 Drive device
97 Recording medium
100, 100y, 101, 102, 103, 104, 105, 10n Communication device
100x Wireless device
110 Communication unit
11, 120 Data transmission/reception unit
120x Transfer unit
121x Sending unit
130 Transfer propriety determination unit
130ax Derivation unit
130bx Determination unit
140 Application unit
12, 150 Storing unit
10, 160 Positional information acquisition unit
171 Movement control unit
172 Movement enabling unit
173 Movement information acquisition unit
201, 202, 203, 204, 205 General device

1. A wireless device comprising:
a derivation unit deriving, from a first position that is included in sent first control information and is a position of a generation-source wireless device in which the first control information is generated, and a second position that is included in second control information to be sent by a candidate wireless device being a candidate for a device to which the first control information is transferred and is a position of the candidate wireless device, a distance between the generation-source wireless device and the candidate wireless device;
a determination unit calculating, by using a predetermined function that exhibits a tendency to decrease with an increase of the distance and always takes a positive value, a probability of transferring the first control information to the candidate wireless device;
a transfer unit performing the transfer based on the probability; and
a sending unit sending the first control information and the second control information to a movement control unit controlling autonomous movement by using the first control information and the second control information.

2. The wireless device according to claim 1, wherein the function asymptotically approaches zero with an increase of the distance.

3. The wireless device according to claim 1, wherein the function is in proportion to, relating to a value acquired by subtracting 1 from a minimum integer equal to or more than a number of the distance divided by a predetermined constant, a reciprocal of 2 raised to a power of the value.

4. The wireless device according to claim 2, wherein the function is in proportion to a second function, and a proportionality constant relating to the proportion is unique for each of the candidate wireless devices.

5. The wireless device according to claim 1, wherein the candidate wireless device is a neighboring wireless device to which the first control information can be sent wirelessly without passing through another wireless device.

6. The wireless device according to claim 1, wherein the transfer is performed through unicasting.

7. The wireless device according to claim 1, wherein the transfer is performed through broadcasting or multicasting.

8. The wireless device according to claim 7, wherein the transfer is performed according to a maximum value of the probability derived for each of a plurality of the candidate wireless devices.

9. The wireless device according to claim 8, wherein the transfer is performed according to a maximum value of the probability derived for each of all of the candidate wireless devices.

10. The wireless device according to claim 1, wherein, when the transfer is performed, the transfer through multicasting is performed for all of the candidate wireless devices.

11. The wireless device according to claim 1, wherein the first control information includes, in addition to the first position, a device ID of the generation-source wireless device and an information ID of the first control information.

12. The wireless device according to claim 1, wherein the second control information includes, in addition to the second position, a device ID of the candidate wireless device and an information ID of the second control information.

13. A wireless system comprising a plurality of the wireless devices according to claim 1.

14. A communication method comprising:
deriving, from a first position that is included in sent first control information and is a position of a generation-source wireless device in which the first control information is generated, and a second position that is included in second control information to be sent by a candidate wireless device being a candidate for a device to which the first control information is transferred and is a position of the candidate wireless device, a distance between the generation-source wireless device and the candidate wireless device;
calculating, by using a predetermined function that exhibits a tendency to decrease with an increase of the distance and always takes a positive value, a probability of transferring the first control information to the candidate wireless device;
performing the transfer based on the probability; and
sending the first control information and the second control information to a movement control unit controlling autonomous movement by using the first control information and the second control information.

15. The communication method according to claim 14, wherein the derivation, the calculation, and the transfer are performed when autonomous movement is performed.

16-23. (canceled)

24. An information transfer device being a communication device wirelessly transferring information between each pair of a plurality of the communication devices, the information transfer device comprising:
a positional information acquisition unit configured to acquire positional information of an own communication device; and
data transmission/reception unit configured to perform the transfer by generating set information including at least a device ID identifying the own communication device, acquired positional information, and an information ID identifying the set information, and configured to perform the transfer of the set information, as transfer target information, being received from a neighboring communication device being the communication device with which direct wireless communication is possible and generated by another of the communication devices, to the neighboring communication device other than a transmission destination of the set information, wherein
the data transmission/reception unit:
calculates, from the positional information being included in the transfer target information and representing a position of a generation-source communication device being a generation source of the set information, and the positional information being notified from a transmission-destination neighboring communication device to which the transfer target information is transferred, an inter-communication-device distance between the generation-source communication device and the neighboring communication device being a transmission destination relating to the transfer;
derives, based on the inter-communication-device distance and a preliminarily set constant, a probability of performing the transfer of the transfer target information to the neighboring communication device; and
performs, based on the probability, the transfer of the transfer target information to the transmission-destination neighboring communication device, and
the information transfer device is the own communication device.

25. An information transfer system comprising a plurality of the communication devices according to claim 24.

26. (canceled)
